(19) United States
(12) Patent Application Publication
(10) Pub. No.: US 2025/0274728 A1
(43) Pub. Date: Aug. 28, 2025

(54) USER EQUIPMENT GROUP AND QUASI-COLLOCATION CONFIGURATION MANAGEMENT

(71) Applicant: QUALCOMM INCORPORATED, San Diego, CA (US)

(72) Inventors: Hui Guo, Beijing (CN); Tien Viet Nguyen, Bridgewater, NJ (US); Karthika Paladugu, Hyderabad (IN); Shuanshuan Wu, San Diego, CA (US); Kapil Gulati, Belle Mead, NJ (US)

(21) Appl. No.: 18/858,265

(22) PCT Filed: Jun. 14, 2022
(86) PCT No.: PCT/CN2022/098609

§ 371 Date: Oct. 18, 2024

(51) Int. Cl. H04W 4/08; H04W 4/02

(52) U.S. Cl. CPC H04W 4/08; H04W 4/02

(57) ABSTRACT

Methods, systems, and devices for wireless communications are described. A user equipment (UE) may receive control signaling including an indication of a group configuration for a UE group associated with the UE. The group configuration may indicate a group leader UE and one or more group member UEs and may indicate an identifier mapping between the group leader UE and the one or more group member UEs, where each of the one or more group member UEs are within a quasi-collocation threshold of the group leader UE. The UE may receive a message for at least one group member UE of the one or more group member UEs based on a level of quasi-collocation relationship between the group leader UE and the at least one group member CE. The UE may transmit, to the at least one group member UE, the message based on the identifier mapping.

### CROSS REFERENCE

The present Application is a 371 national stage filing of International PCT Application No. PCT/CN2022/098609 by Guo et al. entitled “USER EQUIPMENT GROUP AND QUASI-COLLOCATION CONFIGURATION MANAGEMENT,” filed Jun. 14, 2022, which is assigned to the assignee hereof, and which is expressly incorporated by reference in its entirety herein.

### FIELD OF TECHNOLOGY

The following relates to wireless communications, including user equipment group and quasi-collocation configuration management.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). In some wireless communications systems, communications between a vehicle UE and one or more other vehicle UEs, handheld UEs, base stations, roadside units, or the like may be supported.

### SUMMARY

The described techniques relate to improved methods, systems, devices, and apparatuses that support user equipment (UE) group and quasi-collocation configuration management. For example, the described techniques may provide for group formation, varying degrees or levels of quasi-collocation and assumptions that may be made based on the varying degrees or levels of quasi-colocation. In some wireless communications systems, one or more UEs may be connected to a same network entity via a Uu interface and may form a group based on being quasi-collocated. For example, the group may include a group leader UE and one or more group member UEs that are quasi-collocated (e.g., withing a quasi-collocation threshold of the group leader UE). Additionally, the group leader UE and the group member UEs may be connected to each other via a sidelink interface. The group leader UE may form a group with the group member UEs to assist communications between the group member UEs and the network for increased efficiency in the wireless communications system.

For example, a group leader UE may form a group with a number of similarly located (e.g., quasi-collocated) UEs. For example, the group leader UE may receive a number of group confirmation messages from a set of quasi-collocated UEs and, based on determining to form a group, may transmit a group formation request to the serving network entity. The network entity may respond with control signaling indicating a group configuration. The group configuration may include one or more characteristics of the group, such as a group identifier. The group leader UE may relay or forward messages from the network entity to one or more member UEs based on a respective quasi-collocation relationship with the group leader. For example, a member UE may determine that it has a quasi-collocation relationship with the group leader including one or more levels of a plurality of levels. The network may be able to deduct or assume one or more parameters for communications with the member UE from the quasi-collocation relationship with the group leader UE according to the quasi-collocation levels.

A method for wireless communication at a UE is described. The method may include receiving, from a network entity, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi co-location threshold of the group leader UE, receiving a message for at least one group member UE of the one or more group member UEs based on a level of quasi co-location relationship between the group leader UE and the at least one group member UE, and transmitting, to the at least one group member UE, the message based on the identifier mapping.

An apparatus for wireless communication at a UE is described. The apparatus may include a processor, memory coupled with the processor, and instructions stored in the memory. The instructions may be executable by the processor to cause the apparatus to receive, from a network entity, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi co-location threshold of the group leader UE, receive a message for at least one group member UE of the one or more group member UEs based on a level of quasi co-location relationship between the group leader UE and the at least one group member UE, and transmit, to the at least one group member UE, the message based on the identifier mapping.

Another apparatus for wireless communication at a UE is described. The apparatus may include means for receiving, from a network entity, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi co-location threshold of the group leader UE, means for receiving a message for at least one group member UE of the one or more group member UEs based on a level of quasi co-location relationship between the group leader UE and the at least one group member UE, and means for transmitting, to the at least one group member UE, the message based on the identifier mapping.

A non-transitory computer-readable medium storing code for wireless communication at a UE is described. The code may include instructions executable by a processor to receive, from a network entity, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi co-location threshold of the group leader UE, receive a message for at least one group member UE of the one or more group member UEs based on a level of quasi co-location relationship between the group leader UE and the at least one group member UE, and transmit, to the at least one group member UE, the message based on the identifier mapping.

Some examples of the method, apparatuses, and non-transitory computer-readable medium described herein may further include operations, features, means, or instructions for transmitting a group formation request message to initiate group formation based on receiving an approval indication from each of the one or more group member UEs, where receiving the control signaling including the indication of the group configuration may be based on transmitting the group formation request message.

In some examples of the method, apparatuses, and non-transitory computer-readable medium described herein, the group formation request message includes a cell radio network temporary identifier (RNTI) for each of the one or more group member UEs and the group leader UE.

In some examples of the method, apparatuses, and non-transitory computer-readable medium described herein, the group configuration further indicates a group RNTI based on the group formation request message.

Some examples of the method, apparatuses, and non-transitory computer-readable medium described herein may further include operations, features, means, or instructions for transmitting, via sidelink communications, an indication of the group RNTI to each of the one or more group member UEs.

In some examples of the method, apparatuses, and non-transitory computer-readable medium described herein, the indication of the group RNTI may be transmitted via sidelink control information.

In some examples of the method, apparatuses, and non-transitory computer-readable medium described herein, the group RNTI may be randomly generated.

Some examples of the method, apparatuses, and non-transitory computer-readable medium described herein may further include operations, features, means, or instructions for updating the group RNTI based on a periodic refresh window.

In some examples of the method, apparatuses, and non-transitory computer-readable medium described herein, the periodic refresh window may be determined by the network entity or the group leader UE.

Some examples of the method, apparatuses, and non-transitory computer-readable medium described herein may further include operations, features, means, or instructions for updating the group RNTI based on adding randomly-generated group RNTI offset to the group RNTI.

Some examples of the method, apparatuses, and non-transitory computer-readable medium described herein may further include operations, features, means, or instructions for receiving a second group RNTI based on a member UE joining or leaving the group configuration.

In some examples of the method, apparatuses, and non-transitory computer-readable medium described herein, the group configuration further indicates a set of cell RNTIs for each of the one or more group member UEs based on the group formation request message.

Some examples of the method, apparatuses, and non-transitory computer-readable medium described herein may further include operations, features, means, or instructions for receiving a message having the second cell RNTI, determining that decoding of the message at a group member UE may be unsuccessful, and relaying the message to the group member UE.

Some examples of the method, apparatuses, and non-transitory computer-readable medium described herein may further include operations, features, means, or instructions for transmitting a cell RNTI of the group leader UE to each of the one or more group member UEs from which an approval indication may have been received.

In some examples of the method, apparatuses, and non-transitory computer-readable medium described herein, transmitting the message to the at least one group member UE may include operations, features, means, or instructions for relaying the message from the network entity to the at least one group member UE based on the destination identifier.

In some examples of the method, apparatuses, and non-transitory computer-readable medium described herein, transmitting the message to the at least one group member UE may include operations, features, means, or instructions for relaying the message from the network entity to the at least one group member UE via sidelink communications, the method further including and selecting a source identifier and a destination identifier for relaying the message via sidelink communications based on the identifier mapping, where the source identifier and the destination identifier may be different from source identifiers and destination identifiers associated with other sidelink communication types.

Some examples of the method, apparatuses, and non-transitory computer-readable medium described herein may further include operations, features, means, or instructions for maintaining the identifier mapping for future communications with the one or more group member UEs.

In some examples of the method, apparatuses, and non-transitory computer-readable medium described herein, the other sidelink communication types include groupcast communication, or unicast communication, or both.

Some examples of the method, apparatuses, and non-transitory computer-readable medium described herein may further include operations, features, means, or instructions for receiving a destination identifier for each of the one or more group member UEs during a connection establishment procedure and transmitting a source identifier to each of the one or more group member UEs during the connection establishment procedure.

In some examples of the method, apparatuses, and non-transitory computer-readable medium described herein, the connection establishment procedure may be a PC5 unicast link establishment procedure.

Some examples of the method, apparatuses, and non-transitory computer-readable medium described herein may further include operations, features, means, or instructions for transmitting signaling indicating the level of quasi co-location relationship between the group leader UE and each of the one or more group member UEs.

In some examples of the method, apparatuses, and non-transitory computer-readable medium described herein, a first level of quasi co-location relationship between a first group member UE and the group leader UE may be different than a second level of quasi co-location relationship between a second group member UE and the group leader UE.

In some examples of the method, apparatuses, and non-transitory computer-readable medium described herein, a first level of quasi co-location relationship between a first group member UE and the group leader UE may be the same as a second level of quasi co-location relationship between a second group member UE and the group leader UE.

In some examples of the method, apparatuses, and non-transitory computer-readable medium described herein, the level of quasi co-location relationship between the group leader UE and the at least one group member UE may be based on a location of the at least one group member UE within the group leader UE.

In some examples of the method, apparatuses, and non-transitory computer-readable medium described herein, the level of quasi co-location relationship between the group leader UE and the at least one group member UE includes at least one level of a set of multiple levels of quasi co-location relationships.

In some examples of the method, apparatuses, and non-transitory computer-readable medium described herein, a first level may be based on a common direction of travel between the group leader UE and the at least one group member UE.

In some examples of the method, apparatuses, and non-transitory computer-readable medium described herein, a second level may be based on a common timing offset between the group leader UE and the at least one group member UE.

In some examples of the method, apparatuses, and non-transitory computer-readable medium described herein, a third level may be based on a pathloss measurement of the group leader UE and a pathloss measurement of the at least one group member UE satisfying a criterion.

In some examples of the method, apparatuses, and non-transitory computer-readable medium described herein, a fourth level may be based on a reference signal received power of the group leader UE and a reference signal received power of the at least one group member UE satisfying a criterion.

In some examples of the method, apparatuses, and non-transitory computer-readable medium described herein, the level of quasi co-location relationship between the group leader UE and the at least one group member UE may be determined by the network entity, the group leader UE, or the at least one group member UE based on a measurement procedure.

In some examples of the method, apparatuses, and non-transitory computer-readable medium described herein, each group member UE may be associated with a default level of quasi co-location relationship with the group leader UE during group initiation.

In some examples of the method, apparatuses, and non-transitory computer-readable medium described herein, each group member UE may be associated with at least one common level of quasi co-location relationship with the group leader UE.

Some examples of the method, apparatuses, and non-transitory computer-readable medium described herein may further include operations, features, means, or instructions for updating the level of quasi co-location relationship between the group leader UE and the at least one group member UE based on a measurement procedure.

Some examples of the method, apparatuses, and non-transitory computer-readable medium described herein may further include operations, features, means, or instructions for receiving, from the at least one group member UE, an indication of an updated level of quasi co-location relationship between the group leader UE and the at least one group member UE.

In some examples of the method, apparatuses, and non-transitory computer-readable medium described herein, receiving the control signaling may include operations, features, means, or instructions for receiving radio resource control signaling.

A method for wireless communication at a network entity is described. The method may include transmitting, to a UE, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi co-location threshold of the group leader UE, receiving signaling indicating a level of quasi co-location relationship between the group leader UE and each of the one or more group member UEs, and transmitting a message for at least one group member UE of the one or more group member UEs based on the level of quasi co-location relationship between the group leader UE and each of the one or more group member UEs.

An apparatus for wireless communication at a network entity is described. The apparatus may include a processor, memory coupled with the processor, and instructions stored in the memory. The instructions may be executable by the processor to cause the apparatus to transmit, to a UE, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi co-location threshold of the group leader UE, receive signaling indicating a level of quasi co-location relationship between the group leader UE and each of the one or more group member UEs, and transmit a message for at least one group member UE of the one or more group member UEs based on the level of quasi co-location relationship between the group leader UE and each of the one or more group member UEs.

Another apparatus for wireless communication at a network entity is described. The apparatus may include means for transmitting, to a UE, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi co-location threshold of the group leader UE, means for receiving signaling indicating a level of quasi co-location relationship between the group leader UE and each of the one or more group member UEs, and means for transmitting a message for at least one group member UE of the one or more group member UEs based on the level of quasi co-location relationship between the group leader UE and each of the one or more group member UEs.

A non-transitory computer-readable medium storing code for wireless communication at a network entity is described. The code may include instructions executable by a processor to transmit, to a UE, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi co-location threshold of the group leader UE, receive signaling indicating a level of quasi co-location relationship between the group leader UE and each of the one or more group member UEs, and transmit a message for at least one group member UE of the one or more group member UEs based on the level of quasi co-location relationship between the group leader UE and each of the one or more group member UEs.

Some examples of the method, apparatuses, and non-transitory computer-readable medium described herein may further include operations, features, means, or instructions for receiving, from the group leader UE, a group formation request message to initiate group formation based on an approval indication associated with each of the one or more group member UEs, where transmitting the control signaling including the indication of the group configuration may be based on receiving the group formation request message.

In some examples of the method, apparatuses, and non-transitory computer-readable medium described herein, the group configuration further indicates a group RNTI based on the group formation request message.

Some examples of the method, apparatuses, and non-transitory computer-readable medium described herein may further include operations, features, means, or instructions for transmitting a common message for each of the one or more group member UEs including a scrambled group RNTI.

In some examples of the method, apparatuses, and non-transitory computer-readable medium described herein, the group RNTI may be scrambled via downlink control information.

Some examples of the method, apparatuses, and non-transitory computer-readable medium described herein may further include operations, features, means, or instructions for updating the group RNTI based on a periodic refresh window.

Some examples of the method, apparatuses, and non-transitory computer-readable medium described herein may further include operations, features, means, or instructions for determining the periodic refresh window and transmitting an indication of the periodic refresh window to the group leader UE.

Some examples of the method, apparatuses, and non-transitory computer-readable medium described herein may further include operations, features, means, or instructions for receiving, from each of the one or more group member UEs, a cell RNTI of the group leader UE and a cell RNTI of a respective group member UE, where the cell RNTI of the group leader UE indicates to the network entity that the respective group member UE may be in a group with the group leader UE.

In some examples of the method, apparatuses, and non-transitory computer-readable medium described herein, transmitting the message may include operations, features, means, or instructions for transmitting the message to the group leader UE for forwarding to the at least one group member UE including an indication of a destination identifier of the at least one group member UE based on the cell RNTI of the group leader UE and the at least one group member UE.

Some examples of the method, apparatuses, and non-transitory computer-readable medium described herein may further include operations, features, means, or instructions for updating the level of quasi co-location relationship between the group leader UE and the at least one group member UE based on a measurement procedure.

In some examples of the method, apparatuses, and non-transitory computer-readable medium described herein, the level of quasi co-location relationship includes a first level and the method, apparatuses, and non-transitory computer-readable medium may include further operations, features, means, or instructions for receiving a beam indication from the group leader UE for communications with the group leader UE and the at least one group member UE.

In some examples of the method, apparatuses, and non-transitory computer-readable medium described herein, the level of quasi co-location relationship includes a second level and the method, apparatuses, and non-transitory computer-readable medium may include further operations, features, means, or instructions for transmitting a same time advance command to the at least one group member UE and each remaining group member UE.

In some examples of the method, apparatuses, and non-transitory computer-readable medium described herein, the level of quasi co-location relationship includes a third level and the method, apparatuses, and non-transitory computer-readable medium may include further operations, features, means, or instructions for receiving a pathloss measurement from the group leader UE for communications with the at least one group member UE.

Some examples of the method, apparatuses, and non-transitory computer-readable medium described herein may further include operations, features, means, or instructions for receiving, from the group leader UE, an updated pathloss measurement for each of the one or more group member UEs.

In some examples of the method, apparatuses, and non-transitory computer-readable medium described herein, the level of quasi co-location relationship includes a fourth level and the method, apparatuses, and non-transitory computer-readable medium may include further operations, features, means, or instructions for receiving a reference signal received power of the group leader UE, of the at least one group member UE, and a second at least one group member UE, where the reference signal received power of the group leader UE, of the at least one group member UE, and a second at least one member UE each satisfy one or more criteria and transmitting a group handover command to the group leader UE, the at least one group member UE, and the second at least one group member UE.

### BRIEF DESCRIPTION OF THE DRAWINGS

FIG. 1 illustrates an example of a wireless communications system that supports user equipment (UE) group and quasi-collocation configuration management in accordance with one or more aspects of the present disclosure.

FIG. 2 illustrates an example of a wireless communications system that supports UE group and quasi-collocation configuration management in accordance with one or more aspects of the present disclosure.

FIG. 3 illustrates an example of a wireless communications system that supports UE group and quasi-collocation configuration management in accordance with one or more aspects of the present disclosure.

FIG. 4 illustrates an example of a process flow that supports UE group and quasi-collocation configuration management in accordance with one or more aspects of the present disclosure.

FIGS. 5 and 6 show block diagrams of devices that support UE group and quasi-collocation configuration management in accordance with one or more aspects of the present disclosure.

FIG. 7 shows a block diagram of a communications manager that supports UE group and quasi-collocation configuration management in accordance with one or more aspects of the present disclosure.

FIG. 8 shows a diagram of a system including a device that supports UE group and quasi-collocation configuration management in accordance with one or more aspects of the present disclosure.

FIGS. 9 and 10 show block diagrams of devices that support UE group and quasi-collocation configuration management in accordance with one or more aspects of the present disclosure.

FIG. 11 shows a block diagram of a communications manager that supports UE group and quasi-collocation configuration management in accordance with one or more aspects of the present disclosure.

FIG. 12 shows a diagram of a system including a device that supports UE group and quasi-collocation configuration management in accordance with one or more aspects of the present disclosure.

FIGS. 13 through 19 show flowcharts illustrating methods that support UE group and quasi-collocation configuration management in accordance with one or more aspects of the present disclosure.

### DETAILED DESCRIPTION

In some wireless communications systems (e.g., vehicle-to-everything (V2X) wireless communications systems), vehicle user equipments (UEs) may be slated as an impactful mobile platform for further development and use in future wireless communications. Some vehicle UEs (e.g., smart cars) may include sensors such as RADAR, cameras, LIDAR, etc, to assist with autonomous driving and other complex features. For example, a vehicle UE with wireless communications connectivity may be enabled to communicate with one or more elements proximate to the vehicle UE (e.g., infrastructure, other vehicle UEs) to transmit or receive information regarding potential obstacles, traffic jams, or the like, and as such may aid in autonomous driving systems (e.g., such that the vehicle UE or another autonomous vehicle UE may take an alternate route in case of obstacles or traffic jams). Some such vehicle UEs may include radio access technology (RAT) connectivity (e.g., 4G connectivity, 5G connectivity, 6G connectivity) and thus may be able to communicate with a network via a network entity. Moreover, vehicle UEs may additionally communicate with UEs transported or used by a driver of the vehicle UE or in-vehicle (e.g., within the vehicle UE, near the vehicle UE, within a distance threshold of the vehicle UE, within a quasi-collocation threshold of the vehicle UE) passengers, or both via sidelink communications. In some examples, the transported UEs may be enabled to connect to Wi-Fi networks or Bluetooth networks supported by the vehicle UE for various applications (e.g., entertainment, navigations).

Vehicle UEs may improve the user experience for communications via in-vehicle UEs. For example, a vehicle UE may assist wireless communications at in-vehicle UEs by providing side information. That is, because a vehicle UE may be connected to a wireless communications network and may have additional or different sensors than in-vehicle UEs, the vehicle UE may access side information that may be more accurate or may be in addition to information available to each in-vehicle UE. Side information may include accurate timing via GPS measurements, ego location information, surrounding object location information, driving orientation/velocity (e.g., based on navigation and sensor fused data measured by the vehicle UE and sensor sharing information from other vehicle UEs or road side unites (RSUs)), etc. As such, multiple in-vehicle UEs in a same cell and a same vehicle UE may form an in-vehicle group with the vehicle UE for enhanced communications. For example, UEs transported by passengers and drivers may join the group which may be initiated by the vehicle UE.

Each in-vehicle UE may individually determine whether to join the group based on, for example, group discovery signal detecting, channel measurements, and security considerations, or the like. Once the group is formed, vehicle UEs may, for example, share side information with group members, relay data from the network to one or more group members, or the like, thus conserving mobile power, and reducing latency and processing. A group leader UE (e.g., vehicle UE) may be configured with various management procedures and signaling, e.g., group-RNTI assignment and updating, sub-group management etc., to improve group member UE experience while potentially protecting the privacy of group member UEs in some examples.

For example, one or more UEs may form a group of UEs based on similar (e.g., within a threshold) quasi-collocation information. In some instances, the group may include a group leader UE (e.g., vehicle UE) and one or more group member UEs (e.g., passenger UEs). The group leader UE and group member UEs may be connected to a network entity via a radio interface (e.g., Uu interface). Additionally, the group leader UE and the group member UEs may be connected to each other via a sidelink interface (e.g., a PC5 interface). For example, as the group leader UE and the group member UEs are traveling in a same direction at a same velocity, a wireless channel between the network entity and each of the group members may be similar or may share certain properties based on quasi-collocation information. In some examples, the group leader UE may include multi-mode terminals (e.g., multiple connected cars such as train cars, daisy chained personal vehicles, or multiple compartment buses including multiple cells) and as such, multiple groups may be formed in the vehicle UE (e.g., within each compartment, car, or cell of a vehicle UE).

The group leader UE may receive a number of group confirmation messages from one or more quasi-collocation UEs and may transmit a group formation request to a network entity based on receiving the group confirmation messages from the quasi-collocated UEs. In some examples, the group formation request message may include an identifier (e.g., a cell radio network temporary identifier (C-RNTI)) for each group member or the group leader UE, or both. The network entity may respond with control signaling indicating a group configuration which may indicate one or more characteristics of the group or member UEs of the group, or both (e.g., group identifiers, cell identifiers, group leader identifiers, UE identifiers, destination Layer 2 (L2) identifiers, source L2 identifiers, a group RNTI (G-RNTI), C-RNTI, C-RNTI-V, C-RNTI-G). C-RNTI-V or C-RNTI-G may be two examples of identifiers having a same purpose. For security and privacy considerations, C-RNTI may be available to a group member UE, while C-RNTI-V or C-RNTI-G may be a specific RNTI known and used by both group member UEs and the group leader UE, such that the group leader UE may forward downlink packets from a network entity to the respective group member UE once the group member UE has joined the group. As such. when the group member UE leaves the group, C-RNTI-V/C-RNTI-G may not be valid and C-RNTI may be used.

For example, the group leader UE may relay or forward messages from the network entity according to a number of different mechanisms based on the group configuration and a quasi-collocation relationship such that messages are more reliably transmitted to group member UEs while reducing processing and signaling within the system. For example, each group member UE may determine a quasi-collocation relationship with the group leader UE and may communicate the relationship to the network. For example, a group member UE may determine a quasi-collocation relationship with the group leader UE including one or more levels of a plurality of quasi-collocation levels. The network may be able to derive or assume one or more parameters for communications with the member UE based on the quasi-collocation relationship between the group leader UE and the member UE.

Aspects of the present disclosure may be implemented to realize one or more advantages. The described techniques may increase reliability of communications with the group member UEs and may reduce processing associated with determining parameters for communicating with individual group member UEs by deriving or assuming parameters based on quasi-collocation relationship.

In a first example quasi-collocation level, the group leader UE may perform a beam management procedure on behalf of the group which may conserve group member measurement efforts and may reduce implementation complexity at group member UEs. In a second example quasi-collocation level, group members having a quasi-collocation relationship including this second example quasi-collocation level may be associated with a same timing advance and a network entity may transit a timing advance command to a single group member UE which may be used for tuning by other group member UEs, thus conserving signaling and processing at the network entity and the group member UEs. In a third example quasi-collocation level, group members having a quasi-collocation relationship including this third example quasi-collocation level may have a pathloss between the group member UE and the network entity that may be derived by a pathloss measurement between the group leader UE and the network entity when taking account for an estimation of penetration loss due to the geometry or construction of the group leader UE, thus reducing a number of pathloss measurements performed in the system. In some such examples, the pathloss measurement may be updated by the group leader UE on behalf of group member UEs having a quasi-collocation relationship that includes the third example quasi-collocation level. In a fourth example quasi-collocation level, group members having a quasi-collocation relationship including this fourth example quasi-collocation level may be configured for group handover, thus reducing a number of handover procedures performed in the system (e.g., obviating an individual handover procedure for each group member UE).

Thus, by defining quasi-collocation levels for quasi-collocation relationships between the group leader UE and the group member UEs, the signaling and processing efforts by the network entity, the group leader UE and the group member UEs may be reduced thereby increasing efficiency and reliability in communications at the group member UEs.

Aspects of the disclosure are initially described in the context of wireless communications systems. Aspects of the disclosure are further described in the context of a quasi-collocation level configuration and a process flow. Aspects of the disclosure are further illustrated by and described with reference to apparatus diagrams, system diagrams, and flowcharts that relate to UE group and quasi-collocation configuration management.

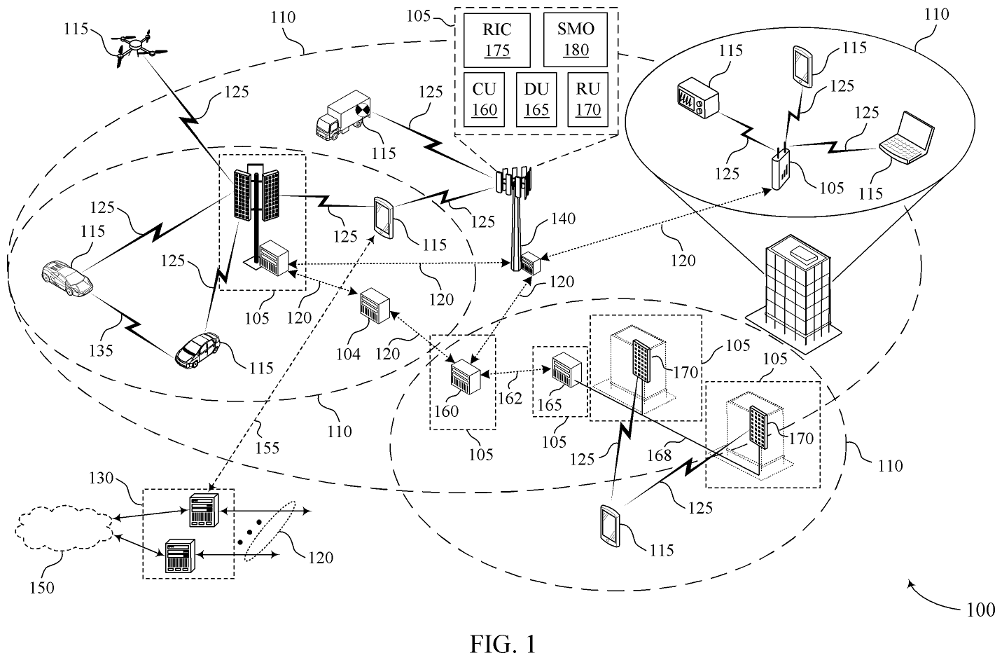

FIG. 1 illustrates an example of a wireless communications system 100 that supports UE group and quasi-collocation configuration management in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), (L2) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (LI) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, Fl-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an FI AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support UE group and quasi-collocation configuration management as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Afmax may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, one or more UEs 115 may form a group initiated by a group leader UE 115. The group may include the group leader UE 115 and one or more group member UEs 115. The group leader UE 115 may transmit a group formation request to the network entity 105. Due to similar quasi-collocation characteristics of the group, the group leader UE 115, the network entity, of the group member UEs 115 may perform one or more procedures on behalf of other group member UEs 115 for determining parameters for communications at the group member UEs 115. For example, the group leader UE 115 may receive control signaling including an indication of a group configuration for a UE group associated with the group leader UE 115. The group configuration may indicate the group leader UE 115 and one or more group member UEs 115 and may indicate an identifier mapping between the group leader UE 115 and the one or more group member UEs 115, where each of the one or more group member UEs 115 are within a quasi-collocation threshold of the group leader UE 115. The group leader UE 115 may receive a message (e.g., from a network entity 105, a roadside unit, or other communication device) for at least one group member UE 115 of the one or more group member UEs 115 based on a level of quasi-collocation relationship between the group leader UE 115 and the at least one group member UE 115. The group leader UE 115 may transmit, to the at least one group member UE 115, the message based on the identifier mapping.

Aspects of the present disclosure may be implemented to realize one or more advantages. The described techniques may reduce the group member UEs 115 communication efforts. For example, the group leader UE 115 may perform one or more procedures with a network entity 105 on behalf of the group, thus, reducing processing and increasing reliability for communications with the group member UEs 115.

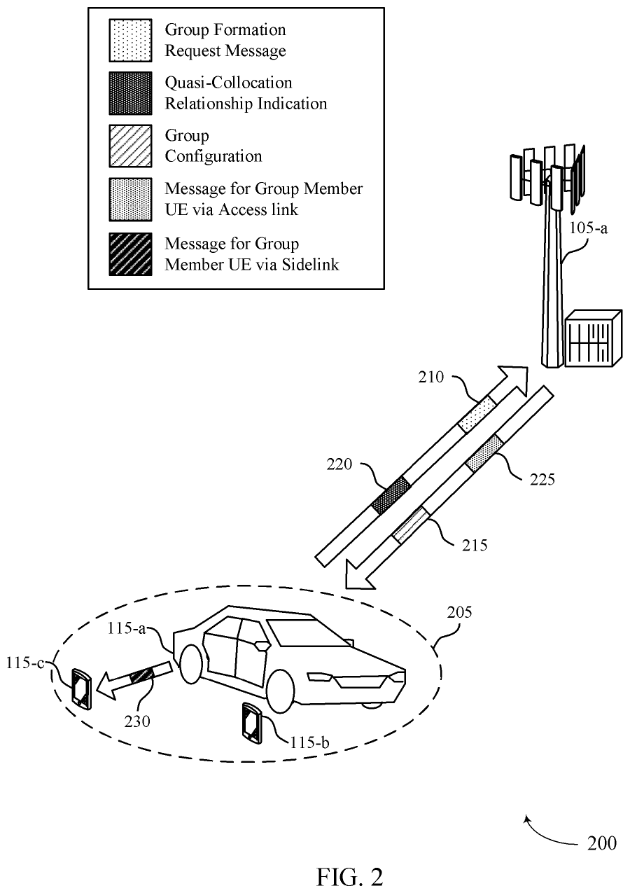

FIG. 2 illustrates an example of a wireless communications system 200 that supports UE group and quasi-collocation configuration management in accordance with one or more aspects of the present disclosure. For example, the wireless communications system 200 may include a network entity 105-a, which may be an example of a network entity 105 described with reference to FIG. 1. Likewise, the wireless communications system 200 may include a UE 115-a, a UE 115-b, and a UE 115-c, which may be examples of a UE 115 described with reference to FIG. 1.

The wireless communications system 200 may be an example of a vehicle-to-everything (V2X) system. For example, the UE 115-a may be an example of a vehicle, and the UE 115-b and the UE 115-c may be examples of mobile devices carried by passengers or the driver of the UE 115-a. The UE 115-a, the UE 115-b, and the UE 115-c may be connected to the network entity 105-a via a Uu interface. The UE 115-a, the UE 115-b, and the UE 115-c may be connected and communicate via a sidelink interface. In some cases, the UE 115-a, the UE 115-b, and the UE 115-c may form a group. The UE 115-a may initiate a group, and the UE 115-b and the UE 115-c may join the group. In some cases, the UE 115-a may be a multi-mode terminal. In such cases, the UEs 115 may form multiple groups in the same vehicle. The UE 115-a may be the group leader UE, while the UE 115-b and the UE 115-c may be group member UEs 115.

For example, the UE 115-a may initiate group formation with the UE 115-b and the UE 115-c based on receiving a group confirmation message from each of the UE 115-b and the UE 115-c. The UE 115-a may transmit a group formation request message 210 to the network entity 105-a requesting a group configuration. The network entity may transmit a group configuration 215 based on receiving the group formation request message 210. The group configuration 215 may include a group identifier (e.g., G-RNTI) assigned to the group which may be considered a response to the group formation request message 210. In some examples, the network entity 105-a may transmit group common packets including the group identifier scrambled by DCI.

In some examples, the UE 115-a may forward an indication of the group identifier to the group member UEs 115-b and 115-c via the sidelink interface. In some other examples, to preserve the privacy of group member UEs 115, the group leader UE 115-a may detect or receive the group identifier from the network entity 105-a and may keep the group identifier private. That is, the group member UEs 115-b and 115-c may not know of be aware of the group identifier which may be a similar mechanism used to preserve the privacy of C-RNTI which may be known by the identified group member UE 115 but not known by other group member UEs 115.

The network entity may transmit a message 225 for one or more of the group member UE 115-b or UE 115-c or both, to the UE 115-a. The UE 115-a may forward the message to the intended recipient. For example, the UE 115-a may select an identifier to differentiate the relayed message from other sidelink transmissions (e.g., other groupcast or unicast transmissions) and may include the identifier in the relayed message. In some examples, the identifier may be a source L2 identifier or a destination L2 identifier or both. The UE 115-a may maintain a mapping of the selected identifiers for each of the group member UEs 115-b and 115-c.

In some examples, the group identifier (e.g., G-RNTI) may be randomly generated and may be updated periodically or semi-periodically. In some such examples, the periodicity for updating the group identifier may be selected or determine by the network entity 105-a or the UE 115-a. The UE 115-a may update the group identifier over time. For example, the UE 115-a may generate or assign a random offset to add to an existing or an initial group identifier. In some examples, the group identifier may be updated when the group composition changes (e.g., when a UE 115 joins or leaves the group).

In some examples, to differentiate from downlink scheduling, the network entity 105-a may assign a group of identifiers (e.g., C-RNTI-G) for each of the UE 115-b and UE 115-c. For example, the network entity 105-a may transmit a message including a cell identifier (e.g., C-RNTI) for downlink communications with a specific group member UE 115, or including a virtual cell identifier (e.g., C-RNTI-V) for downlink packets intended for the group leader UE 115-a and the group member UEs 115-b or UE 115-c, or both. The message intended for the group leader UE 115-a and the group member UEs 115-b or UE 115-c or both, may be relayed, via sidelink, by the UE 115-a to the group member UE 115 when decoding by the group member UE 115 fails.

Additionally, or alternatively, an identifier (e.g., C-RNTI) of the UE 115-a may be known by group member UEs 115-b and 115-c while identifiers of the UE 115-b and UE 115-c (e.g., C-RNTI) may not be known by the UE 115-a. In some such examples, when the UE 115-a receives the group confirmation message from the UE 115-b or the UE 115-c or both, the UE 115-a may respond with an identifier of the UE 115-a (e.g., C-RNTI of the UE 115-a). Each group member UE 115-b and UE 115-c may report the identifier of the UE 115-a to the network entity 105-a along with an identifier of the UE 115-b and an identifier of the UE 115-c, respectively. As such, the network entity may determine that UE 115-b and UE 115-c belong to a same group while UE 115-b and UE 115-c do not.

In some such examples, the UE 115-a may not determine the identifier (e.g., C-RNTI) of the UE 115-b or the UE 115-c. That is, the network entity may determine or receive an indication of the identifier of the UE 115-a (e.g., C-RNTI of the UE 115-a), an identifier of the UE 115-b (e.g., C-RNTI of the UE 115-b) as well as a destination L2 identifier of the UE 115-b, and an identifier of the UE 115-c (e.g., C-RNTI of the UE 115-c) as well as a destination L2 identifier of the UE 115-c. If the network entity 105-a transmits a message 225 to the UE 115-a for relay to at least one of the group member UEs 115-b or 115-c or both, the network entity 105-a may include a destination L2 identifier of the intended recipient (e.g., may not include a C-RNTI of the intended recipient) in the message 225. In some such examples, the UE 115-a may relay the message 230 to the intended group member UE 115 via sidelink. Additionally, or alternatively, during PCSunicast link establishment, L2 identifiers may be exchanged and used for relayed communications between the UE 115-a and the group member UEs 115.

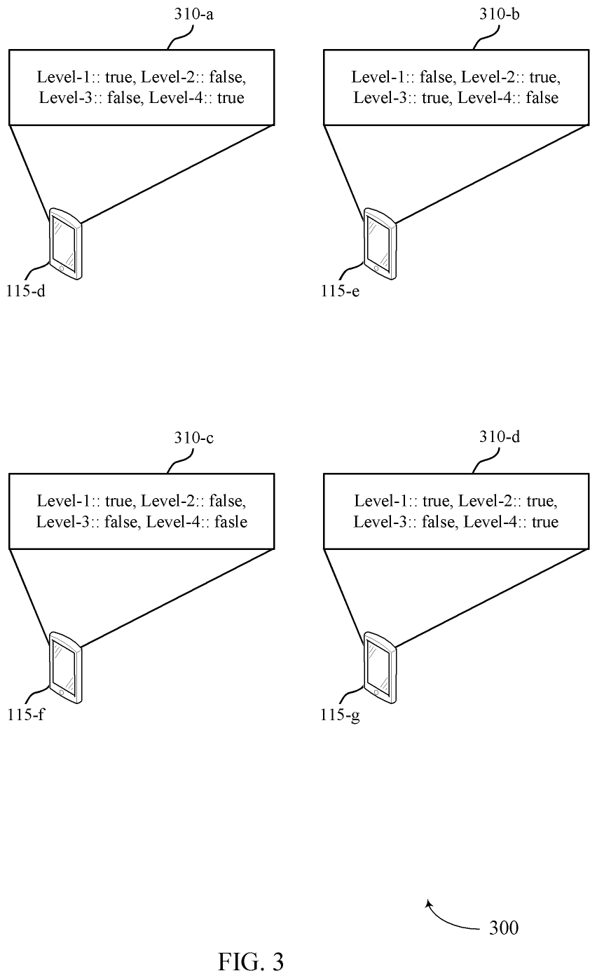

In some examples, the message 225 may be transmitted or relayed to a group member UE 115-b or UE 115-c or both based on a quasi-collocation relationship between the group member UE 115 and the group leader UE 115-a. For example, because the UE 115-a, the UE 115-b, and the UE 115-c may generally move in the same direction at the same velocity, the wireless channel between the network entity 105-a and the UEs 115 may have similar quasi-collocation characteristics. A quasi-collocation relationship may be based on sharing a proximity with the vehicle UE 115-a (e.g., within or near a same car) but not necessarily sharing an exact location. A respective quasi-collocation relationship may be detected by the respective group member UE 115 or may be detected by the UE 115-a for each group member UE 115 or may be determined by the network entity 105-a based on respective measurements in uplink channels, downlink channel or sidelink channels. For example, the UE 115-b may detect or measure a channel and transmit a quasi-collocation relationship indication 220 to the network entity 105-a. In some examples, the quasi-collocation relationship may be the same for all group member UEs 115 or may vary based on the respective quasi-collocation relationship report. The quasi-collocation relationship may include a plurality of levels and each level may apply or not apply to the group member UEs 115 independently from other levels. That is, for example, a higher level may apply while a lower level may not apply, and vice versa. In some examples, the quasi-collocation relationship may initially be a default quasi-collocation relationship during group initiation and may change based on measurements, changes in motion or direction, or the like, where each level of the quasi-collocation relationship may be updated or maintained. The definition of each level may be maintained via higher layer signaling at each device in the wireless communications system 200. Each level may be explained in further detail with respect to FIG. 3. Other levels or types of dynamic group management by be indicated via control signaling (e.g., RRC signaling).

In some examples, the network entity 105, a group member UE 115, or the group leader UE 115 may determine quasi-collocation levels for communicating in the group based on RSRP measurement, a pathloss model, beam strength measurement, etc. As such communications between the network entity 105-a, the group leader UE 115-a, and the group member UEs 115-b and 115-c may be based on a respective quasi-collocation relationship.

Thus, one or more procedures for determining communication parameters may be utilized to maximally leverage the same motional status for the UEs 115. In other words, the UE 115-a, the UE 115-b, and the UE 115-c may be within a quasi-collocation threshold 205, thus having one or more similar quasi-collocation characteristics (e.g., represented by quasi-collocation levels) which may be referred to as a quasi-collocation relationship. For example, a quasi-collocation relationship between the UE 115-a and the UE 115-b may include a same set, a subset, or a super set of quasi-collocation levels as a quasi-collocation relationship between the UE 115-a and the UE 115-c. The UE 115-a or the network entity 105-a may leverage the similar quasi-collocation characteristics to reduce signaling and processing and increase reliability for communications at the UE 115-b or the UE 115-c, or both.

FIG. 3 illustrates an example of a wireless communications system 300 that supports UE group and quasi-collocation configuration management in accordance with one or more aspects of the present disclosure. For example, the wireless communications system 300 may include a UE 115-d, a UE 115-e, a UE 115-f, and a UE 115-g, which may be examples of a UE 115 described with reference to FIGS. 1 and 2. Each of the UE 115-d, UE 115-e, UE 115-f, and UE 115-g may be within a quasi-collocation threshold and may be a member of a same group supported by a group leader UE or may not be within a quasi-collocation threshold and may be members of different groups supported by different group leader UEs, each of which may be an example of a group leader UE 115 described with reference to FIGS. 1 and 2.

The wireless communications system 300 may illustrate an example in which each of the UE 115-d, UE 115-e, UE 115-f, and UE 115-g have individual quasi-collocation relationships with a group leader UE. That is, each UE 115-d, UE 115-e, UE 115-f, and UE 115-g may have a different quasi-collocation relationship with a group leader UE. It is to be understood that the variance of the quasi-collocation relationships associated with each of UEs is an example and any of the quasi-collocation relationships may be the same as another (e.g., need not necessarily be different even though the quasi-collocation relationships are illustrated as being unique for the purposes of explanation and clarity).

Each quasi-collocation relationship may include an indication of whether each of four levels of quasi-collocation status apply to the communications at the respective group member UEs 115. For example, an indication of true for a quasi-collocation level may indicate that the conditions defined in that level are shared by the group leader UE and the respective group member UE 115, while false may indicate that the conditions defined in that level are not shared by the group leader UE and the respective group member UE 115.

A first level may be defined by travel in a similar direction or orientation. For example, group member UEs 115 may travel in a same direction as the group leader UE, and as such it may be possible for a network entity to select a same or wider downlink transmission beam for transmissions to the group leader UE and the group member UEs 115 which have a quasi-collocation relationship with Level 1 set to true. In some such examples, the network entity may perform a beam measurement procedure with the group leader UE which may report a downlink transmission beam or a wider downlink transmission beam based on the procedure. The network entity may receive the report and may perform a beam measurement procedure with a group member UE 115 having Level 1 QLC set to true. The group member UE 115 may measure and report finer beams from the wider reported beam. That is, the group member UE 115 may perform a beam refining procedure based on the beam measurement procedure performed by the group leader UE. Alternatively, the network entity may use the wider transmission beam reported by the group leader UE without performing further beam producers with the group member UEs 115. Either implementation conserves resources at the group member UEs 115 by minimizing measurements and complexity at the group member UEs 115 having Level 1 set to true. In general, it may be likely that group member UEs 115 may have a quasi-collocation Level 1 set to true when being transported by the group leader UE.

A second level may be defined by the group leader UE and a group member UE 115 having a same or similar timing offset or by applying a same timing advance command. For UE group members 115 having Level 2 set to true (which, in some examples may be a default level for all group members), the network entity may indicate a timing advance to each group member UE 115 (e.g., for which Level 2 quasi-collocation is true) based on a timing advance for a single group member UE 115 for uplink reception. In some examples, the network entity may transmit a first timing advance value to a subset of group member UEs 115 for which Level 2 quasi-collocation is true and may transmit a second timing advance value to a subset of group member UEs 115 for which Level 2 quasi-collocation is true based on initial timing advance measurements.

A third level may be defined by adjustment of pathloss measurement. For example, a pathloss measurement from each UE 115 in a same group or car may be similar, for example, as illustrated with reference to Equation 1, below.

$$P {L}_{< {UE}_{veh} gNB >} ≅ P {L}_{< {UE}_{1} gNB >} - P {L}_{< {UE}_{1} {UE}_{veh}}^{Penetration} \qquad [ 1 ]$$

For example, a pathloss between a group member UE 115 (e.g., UE1 and the network entity (e.g., gNB) may be derived based on the pathloss measured between the group leader UE (e.g., UEᵥₑₕ) and the network entity (e.g., gNB) as well as an estimation of the compartment or car penetration loss value (e.g., PL_{<UE}_{₁}_{UE}_{ᵥₑₕ}^{Penetration}). In some examples, the estimation of penetration loss may be a constant value by based on UE experience, or measurement through sidelink, among other examples. Additionally, or alternatively, the pathloss measurement may be updated (e.g., periodically, semi-periodically, based on a trigger) by the group leader UE and transmitted to the network entity on behalf of group members for which Level 3 quasi-collocation is set to true.

Additionally, or alternatively, the network entity may perform one or more management procedures for uplink power control based on quasi-collocation Level 3. For example, the network entity may indicate group-level transmission power control to adjust uplink transmission power for all group members (e.g., all group members having a quasi-collocation relationship with level 3 set to true). In some other examples, the network entity may adjust the uplink transmission power for a subset of group member UE 115, without performing an uplink measurement for each group member UE 115.

A fourth level may be define by a group handover command. For example, a network entity may configure (e.g., dynamically) adjacent cell RSRP measurement among group member UEs 115. For example, some group member UEs 115 or the group leader UE may be configured by the network entity to measure adjacent cell RSRP to save overall UE measurement effort and to improve cell-level downlink reception throughput. When the measured RSRP meets a set of criteria, the network entity may transmit a handover command to all members of the group (e.g., when all group member UEs 115 have Level 4 set to true) for performing a handover procedure as a group (e.g., group handover).

Each quasi-collocation relationship may be different or may have a same subset of levels. In the example of wireless communications system 300, UE 115-d may have a quasi-collocation relationship 310-a with the group leader UE where Level-1 is true, Level-2 is false, Level-3 is false, and Level-4 is true. UE 115-e may have a quasi-collocation relationship 310-b with the group leader UE where Level-1 is false, Level-2 is true, Level-3 is true, and Level-4 is false. UE 115-f may have a quasi-collocation relationship 310-c with the group leader UE where Level-1 is true, Level-2 is false, Level-3 is false, and Level-4 is false. UE 115-g may have a quasi-collocation relationship 310-d with the group leader UE where Level-1 is true, Level-2 is true, Level-3 is false, and Level-4 is true.

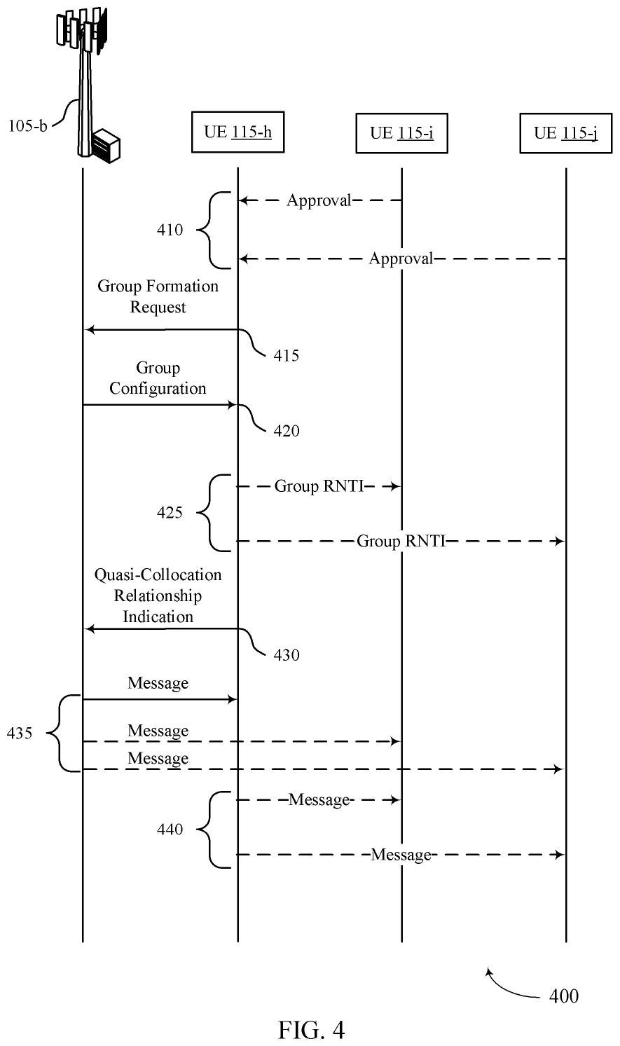

FIG. 4 illustrates an example of a process flow 400 that supports UE group and quasi-collocation configuration management in accordance with one or more aspects of the present disclosure. For example, the process flow 300 may include a network entity 105-b, which may be an example of corresponding network entities 105 described with reference to FIGS. 1 and 2. Likewise, the process flow 300 may include a UE 115-h, a UE 115-i, and a UE 115-j which may be examples of corresponding UEs 115 described with reference to FIGS. 1 through 3.

At 410, the UE 115-h, may receive group approval (e.g., group confirmation) messages from each of the UE 115-i, and the UE 115-j may determine to form a group. For example, the UE 115-i and the UE 115-i may be within a quasi-collocation threshold of the UE 115-h and may be eligible for group formation and communications with the UE 115-h.

At 415, the UE 115-h may transmit, and the network entity 105-b may receive, a group formation request that, in some examples, includes an indication of one or more identifiers (e.g., C-RNTI) associated with the UE 115-h, the UE 115-i, or the UE 115-j, or any combination thereof. For example, the group request indication may include identification of the group leader UE 115-h, the group member UEs 115-i and 115-j, and an identifier mapping between the UE 115-h, the UE 115-i, and the UE 115-j.

At 420, the UE 115-h may receive control signaling (e.g., RRC signaling, DCI) including a group configuration message which, in some examples, may include a group identifier (e.g., G-RNTI, C-RNTI-G, C-RNTI-V) or individual identifiers (e.g., C-RNTI). The group configuration message or the group request message may indicate that the UE 115-h is the group leader UE and the UE 115-i and the UE 115-j are group member UEs 115. In some examples, the UE 115-h, the UE 115-i, and the UE 115-j may join a same in-vehicle group with the UE 115-h being an example of a UE 115-a described herein with reference to FIG. 2. The group configuration message may indicate an identifier mapping between the group leader UE and the one or more member UEs (e.g., destination L2 identifier, source L2 identifier).

At 425, the UE 115-h may transmit, via sidelink, a message indicating the group identifier to each of the group member UEs 115-i and 115-j.

At 430, the UE 115-h may transmit a quasi-collocation relationship indication to the network entity 105-b. For example, the quasi-collocation relationship indication may indicate a quasi-collocation relationship between the UE 115-h and the UE 115-i or between the UE 115-h and the UE 115-j or both. In some examples, the level of quasi-collocation relationship between the UE 115-h and the group member UE 115-i or 115-j or both may include at least one level of a plurality of levels of quasi-collocation relationships. For example, a subset of available levels may be set to true while a subset of available levels may be set to false. In some examples, a first level may be on a common direction of travel between the UE 115-h and at least one group member UE 115-i or UE 115-j, a second level may be based on a common timing offset between the UE 115-h and at least one group member UE 115-i or UE 115-j, a third level may be based on a pathloss measurement of the UE 115-h and a pathloss measurement of at least one group member UE 115-i or UE 115-j satisfying a criterion, and a fourth level may be based on an RSRP of the UE 115-h and an RSRP of at least one group member UE 115-i or UE 115-j satisfying a criterion.

At 435, the network entity 105-b may transmit a message for at least one of the group member UEs 115-i or 115-j or for the group member UEs 115-i and 115-j and the group leader UE 115-h, or both based on a level of quasi-collocation associated with the intended recipients. In some examples, the network entity 105-b may transmit a message intended for the UE 115-i or the UE 115-j or both or may transmit a message intended for the UE 115-h and the UEs 115-i and 115-j.

At 440, the UE 115-h may forward or relay the message received at 435 via sidelink based on identifiers received via the group configuration (e.g., G-RNTI, source L2 identifier, destination L2 identifier, C-RNTI, C-RNTI-G, C-RNTI-V). For example, the message received at 435 may be intended for one of the UE 115-i or UE 115-j and the UE 115-h may relay the message accordingly. In some other examples, the message received at 435 may be intended for the UE 115-h, the UE 115-i, and the UE 115-j, however decoding at one of the group member UEs 115-i or UE 115-j or both failed and thus the message may be forwarded again from the UE 115-h increasing reliability at the receiving group member UE 115.

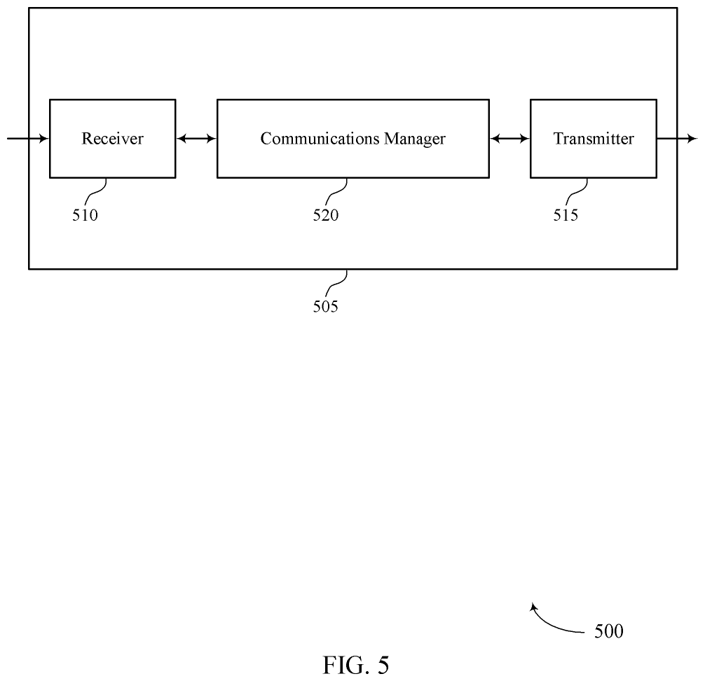

FIG. 5 shows a block diagram 500 of a device 505 that supports UE group and quasi-collocation configuration management in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to UE group and quasi-collocation configuration management). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to UE group and quasi-collocation configuration management). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of UE group and quasi-collocation configuration management as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving, from a network entity, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi-collocation threshold of the group leader UE. The communications manager 520 may be configured as or otherwise support a means for receiving a message for at least one group member UE of the one or more group member UEs based on a level of quasi-collocation relationship between the group leader UE and the at least one group member UE. The communications manager 520 may be configured as or otherwise support a means for transmitting, to the at least one group member UE, the message based on the identifier mapping.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for more efficient utilization of communication resources, among other examples.

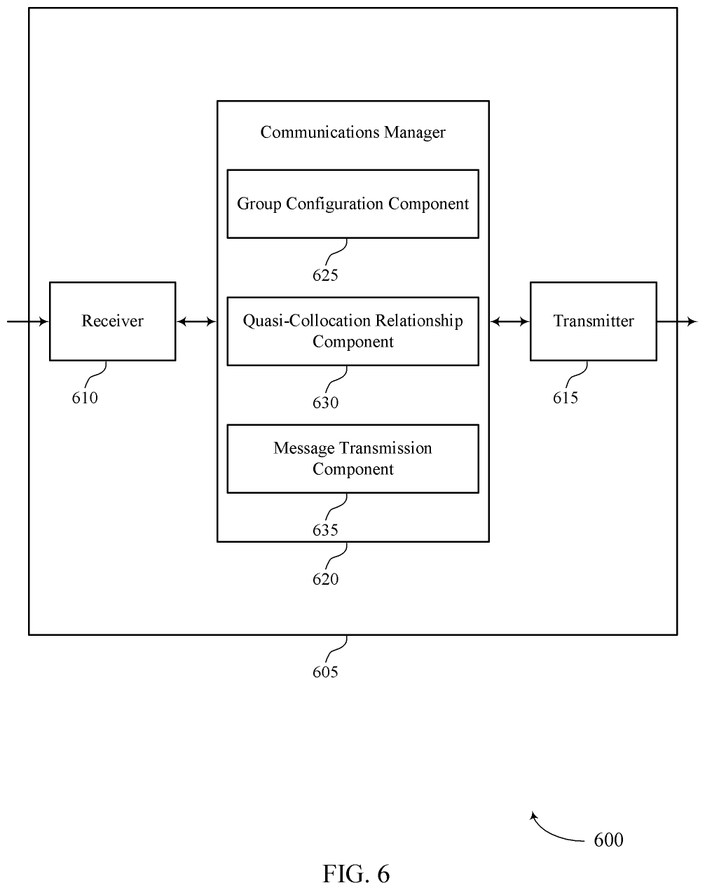

FIG. 6 shows a block diagram 600 of a device 605 that supports UE group and quasi-collocation configuration management in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to UE group and quasi-collocation configuration management). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to UE group and quasi-collocation configuration management). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of UE group and quasi-collocation configuration management as described herein. For example, the communications manager 620 may include a group configuration component 625, a quasi-collocation relationship component 630, a message transmission component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The group configuration component 625 may be configured as or otherwise support a means for receiving, from a network entity, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi-collocation threshold of the group leader UE. The quasi-collocation relationship component 630 may be configured as or otherwise support a means for receiving a message for at least one group member UE of the one or more group member UEs based on a level of quasi-collocation relationship between the group leader UE and the at least one group member UE. The message transmission component 635 may be configured as or otherwise support a means for transmitting, to the at least one group member UE, the message based on the identifier mapping.

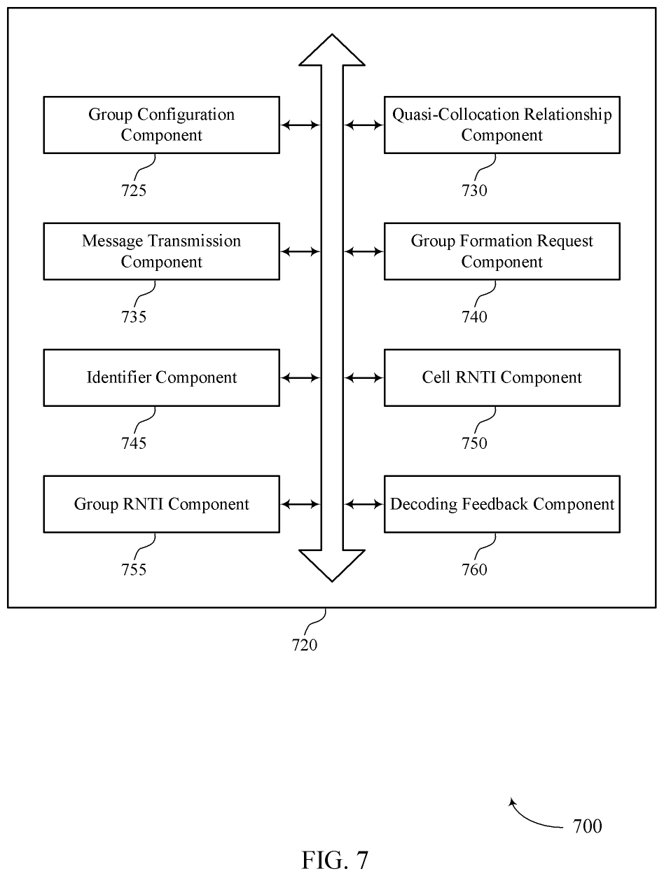

FIG. 7 shows a block diagram 700 of a communications manager 720 that supports UE group and quasi-collocation configuration management in accordance with one or more aspects of the present disclosure. The communications manager 720 may be an example of aspects of a communications manager 520, a communications manager 620, or both, as described herein. The communications manager 720, or various components thereof, may be an example of means for performing various aspects of UE group and quasi-collocation configuration management as described herein. For example, the communications manager 720 may include a group configuration component 725, a quasi-collocation relationship component 730, a message transmission component 735, a group formation request component 740, an identifier component 745, a cell RNTI component 750, a group RNTI component 755, a decoding feedback component 760, or any combination thereof. Each of these components may communicate, directly or indirectly, with one another (e.g., via one or more buses).

The communications manager 720 may support wireless communication at a UE in accordance with examples as disclosed herein. The group configuration component 725 may be configured as or otherwise support a means for receiving, from a network entity, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi-collocation threshold of the group leader UE. The quasi-collocation relationship component 730 may be configured as or otherwise support a means for receiving a message for at least one group member UE of the one or more group member UEs based on a level of quasi-collocation relationship between the group leader UE and the at least one group member UE. The message transmission component 735 may be configured as or otherwise support a means for transmitting, to the at least one group member UE, the message based on the identifier mapping.

In some examples, the group formation request component 740 may be configured as or otherwise support a means for transmitting a group formation request message to initiate group formation based on receiving an approval indication from each of the one or more group member UEs, where receiving the control signaling including the indication of the group configuration is based on transmitting the group formation request message.

In some examples, the group formation request message includes a cell radio network temporary identifier (RNTI) for each of the one or more group member UEs and the group leader UE.

In some examples, the group configuration further indicates a group radio network temporary identifier (RNTI) based on the group formation request message.

In some examples, the group RNTI component 755 may be configured as or otherwise support a means for transmitting, via sidelink communications, an indication of the group RNTI to each of the one or more group member UEs.

In some examples, the indication of the group RNTI is transmitted via sidelink control information.

In some examples, the group RNTI is randomly generated.

In some examples, the group RNTI component 755 may be configured as or otherwise support a means for updating the group RNTI based on a periodic refresh window.

In some examples, the periodic refresh window is determined by the network entity or the group leader UE.

In some examples, the group RNTI component 755 may be configured as or otherwise support a means for updating the group RNTI based on adding randomly-generated group RNTI offset to the group RNTI.

In some examples, the group RNTI component 755 may be configured as or otherwise support a means for receiving a second group RNTI based on a member UE joining or leaving the group configuration.

In some examples, the group configuration further indicates a set of cell radio network temporary identifiers (RNTIs) for each of the one or more group member UEs based on the group formation request message.

In some examples, the cell RNTI component 750 may be configured as or otherwise support a means for receiving a message having the second cell RNTI. In some examples, the decoding feedback component 760 may be configured as or otherwise support a means for determining that decoding of the message at a group member UE is unsuccessful. In some examples, the message transmission component 735 may be configured as or otherwise support a means for relaying the message to the group member UE.

In some examples, the cell RNTI component 750 may be configured as or otherwise support a means for transmitting a cell radio network temporary identifier (RNTI) of the group leader UE to each of the one or more group member UEs from which an approval indication has been received.

In some examples, to support transmitting the message to the at least one group member UE, the message transmission component 735 may be configured as or otherwise support a means for relaying the message from the network entity to the at least one group member UE based on the destination identifier.

In some examples, to support transmitting the message to the at least one group member UE, the message transmission component 735 may be configured as or otherwise support a means for relaying the message from the network entity to the at least one group member UE via sidelink communications. In some examples, to support transmitting the message to the at least one group member UE, the identifier component 745 may be configured as or otherwise support a means for selecting a source identifier and a destination identifier for relaying the message via sidelink communications based on the identifier mapping, where the source identifier and the destination identifier are different from source identifiers and destination identifiers associated with other sidelink communication types.

In some examples, the identifier component 745 may be configured as or otherwise support a means for maintaining the identifier mapping for future communications with the one or more group member UEs.

In some examples, the other sidelink communication types include groupcast communication, or unicast communication, or both.

In some examples, the identifier component 745 may be configured as or otherwise support a means for receiving a destination identifier for each of the one or more group member UEs during a connection establishment procedure. In some examples, the identifier component 745 may be configured as or otherwise support a means for transmitting a source identifier to each of the one or more group member UEs during the connection establishment procedure.

In some examples, the connection establishment procedure is a PC5 unicast link establishment procedure.

In some examples, the quasi-collocation relationship component 730 may be configured as or otherwise support a means for transmitting signaling indicating the level of quasi-collocation relationship between the group leader UE and each of the one or more group member UEs.

In some examples, a first level of quasi-collocation relationship between a first group member UE and the group leader UE is different than a second level of quasi-collocation relationship between a second group member UE and the group leader UE.

In some examples, a first level of quasi-collocation relationship between a first group member UE and the group leader UE is the same as a second level of quasi-collocation relationship between a second group member UE and the group leader UE.

In some examples, the level of quasi-collocation relationship between the group leader UE and the at least one group member UE is based on a location of the at least one group member UE within the group leader UE.

In some examples, the level of quasi-collocation relationship between the group leader UE and the at least one group member UE includes at least one level of a set of multiple levels of quasi-collocation relationships.

In some examples, a first level is based on a common direction of travel between the group leader UE and the at least one group member UE.

In some examples, a second level is based on a common timing offset between the group leader UE and the at least one group member UE.

In some examples, a third level is based on a pathloss measurement of the group leader UE and a pathloss measurement of the at least one group member UE satisfying a criterion.

In some examples, a fourth level is based on a reference signal received power of the group leader UE and a reference signal received power of the at least one group member UE satisfying a criterion.

In some examples, the level of quasi-collocation relationship between the group leader UE and the at least one group member UE is determined by the network entity, the group leader UE, or the at least one group member UE based on a measurement procedure.

In some examples, each group member UE is associated with a default level of quasi-collocation relationship with the group leader UE during group initiation.

In some examples, each group member UE is associated with at least one common level of quasi-collocation relationship with the group leader UE.

In some examples, the quasi-collocation relationship component 730 may be configured as or otherwise support a means for updating the level of quasi-collocation relationship between the group leader UE and the at least one group member UE based on a measurement procedure.

In some examples, the quasi-collocation relationship component 730 may be configured as or otherwise support a means for receiving, from the at least one group member UE, an indication of an updated level of quasi-collocation relationship between the group leader UE and the at least one group member UE.

In some examples, to support receiving the control signaling, the group configuration component 725 may be configured as or otherwise support a means for receiving radio resource control signaling.

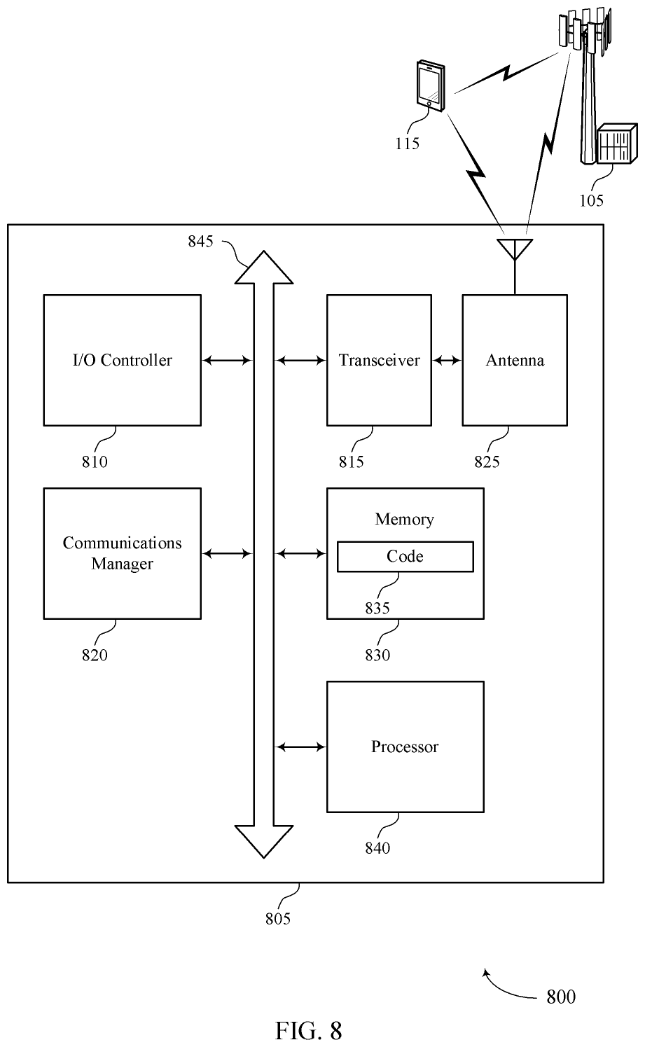

FIG. 8 shows a diagram of a system 800 including a device 805 that supports UE group and quasi-collocation configuration management in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting UE group and quasi-collocation configuration management). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving, from a network entity, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi-collocation threshold of the group leader UE. The communications manager 820 may be configured as or otherwise support a means for receiving a message for at least one group member UE of the one or more group member UEs based on a level of quasi-collocation relationship between the group leader UE and the at least one group member UE. The communications manager 820 may be configured as or otherwise support a means for transmitting, to the at least one group member UE, the message based on the identifier mapping.

By including or configuring the communications manager 820 in accordance with examples as described herein, the device 805 may support techniques for improved communication reliability, more efficient utilization of communication resources, and improved coordination between devices, among other examples.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of UE group and quasi-collocation configuration management as described herein, or the processor 840 and the memory 830 may be otherwise configured to perform or support such operations.

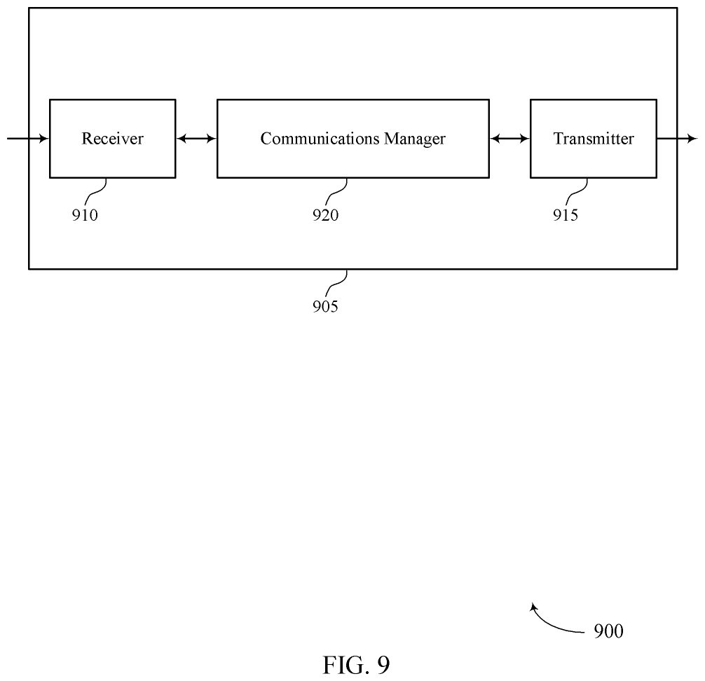

FIG. 9 shows a block diagram 900 of a device 905 that supports UE group and quasi-collocation configuration management in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of UE group and quasi-collocation configuration management as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for transmitting, to a UE, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi-collocation threshold of the group leader UE. The communications manager 920 may be configured as or otherwise support a means for receiving signaling indicating a level of quasi-collocation relationship between the group leader UE and each of the one or more group member UEs. The communications manager 920 may be configured as or otherwise support a means for transmitting a message for at least one group member UE of the one or more group member UEs based on the level of quasi-collocation relationship between the group leader UE and each of the one or more group member UEs.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient utilization of communication resources, among other examples

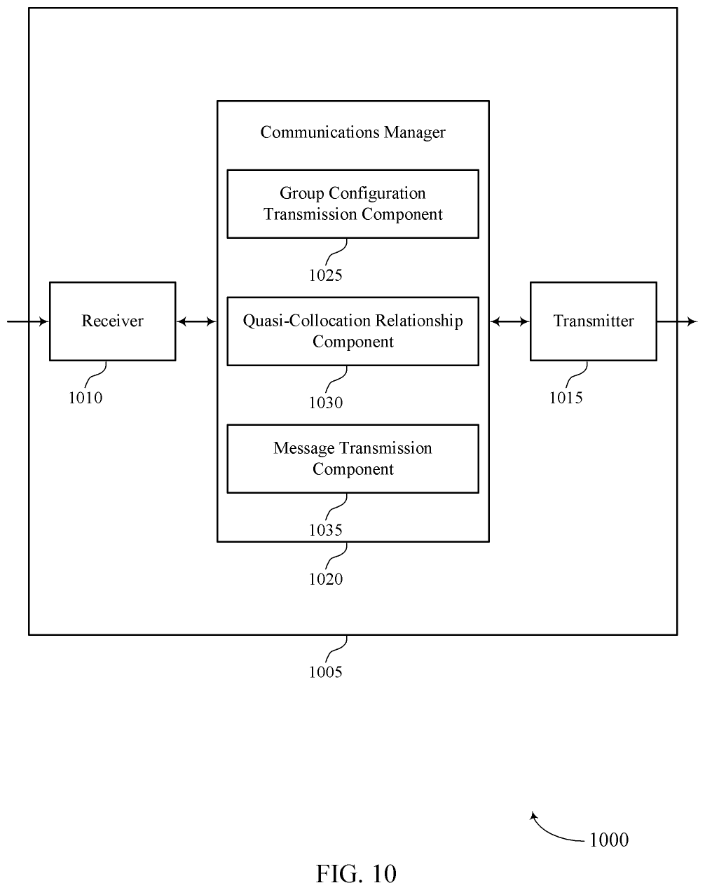

FIG. 10 shows a block diagram 1000 of a device 1005 that supports UE group and quasi-collocation configuration management in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of UE group and quasi-collocation configuration management as described herein. For example, the communications manager 1020 may include a group configuration transmission component 1025, a quasi-collocation relationship component 1030, a message transmission component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The group configuration transmission component 1025 may be configured as or otherwise support a means for transmitting, to a UE, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi-collocation threshold of the group leader UE. The quasi-collocation relationship component 1030 may be configured as or otherwise support a means for receiving signaling indicating a level of quasi-collocation relationship between the group leader UE and each of the one or more group member UEs. The message transmission component 1035 may be configured as or otherwise support a means for transmitting a message for at least one group member UE of the one or more group member UEs based on the level of quasi-collocation relationship between the group leader UE and each of the one or more group member UEs.

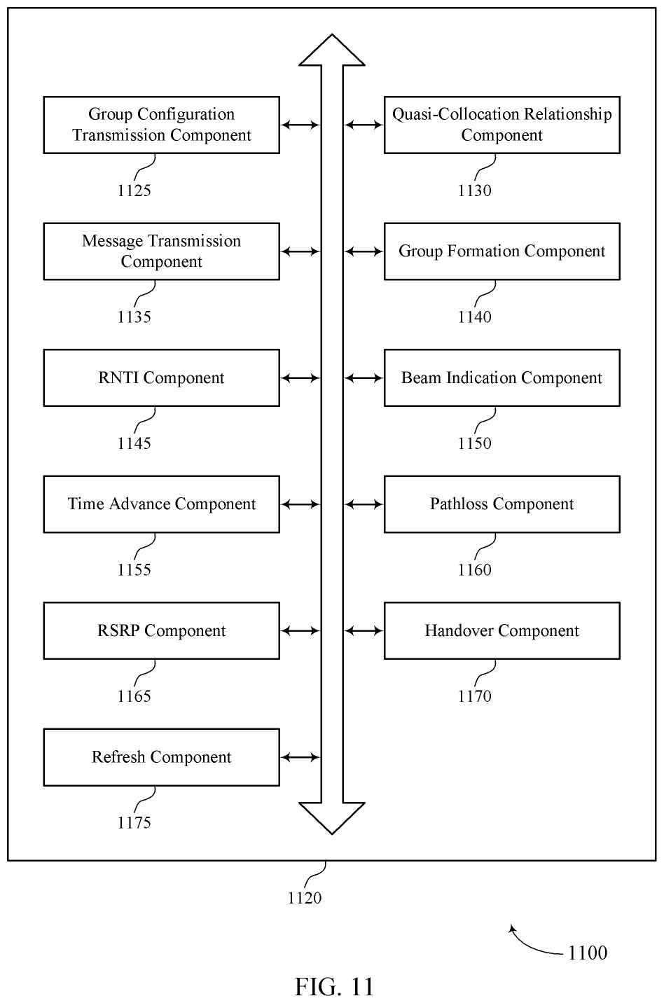

FIG. 11 shows a block diagram 1100 of a communications manager 1120 that supports UE group and quasi-collocation configuration management in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of UE group and quasi-collocation configuration management as described herein. For example, the communications manager 1120 may include a group configuration transmission component 1125, a quasi-collocation relationship component 1130, a message transmission component 1135, a group formation component 1140, an RNTI component 1145, a beam indication component 1150, a time advance component 1155, a pathloss component 1160, an RSRP component 1165, a handover component 1170, a refresh component 1175, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The group configuration transmission component 1125 may be configured as or otherwise support a means for transmitting, to a UE, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi-collocation threshold of the group leader UE. The quasi-collocation relationship component 1130 may be configured as or otherwise support a means for receiving signaling indicating a level of quasi-collocation relationship between the group leader UE and each of the one or more group member UEs. The message transmission component 1135 may be configured as or otherwise support a means for transmitting a message for at least one group member UE of the one or more group member UEs based on the level of quasi-collocation relationship between the group leader UE and each of the one or more group member UEs.

In some examples, the group formation component 1140 may be configured as or otherwise support a means for receiving, from the group leader UE, a group formation request message to initiate group formation based on an approval indication associated with each of the one or more group member UEs, where transmitting the control signaling including the indication of the group configuration is based on receiving the group formation request message.

In some examples, the group configuration further indicates a group radio network temporary identifier (RNTI) based on the group formation request message.

In some examples, the RNTI component 1145 may be configured as or otherwise support a means for transmitting a common message for each of the one or more group member UEs including a scrambled group RNTI.

In some examples, the group RNTI is scrambled via downlink control information.

In some examples, the RNTI component 1145 may be configured as or otherwise support a means for updating the group RNTI based on a periodic refresh window.

In some examples, the refresh component 1175 may be configured as or otherwise support a means for determining the periodic refresh window. In some examples, the refresh component 1175 may be configured as or otherwise support a means for transmitting an indication of the periodic refresh window to the group leader UE.

In some examples, the RNTI component 1145 may be configured as or otherwise support a means for receiving, from each of the one or more group member UEs, a cell RNTI of the group leader UE and a cell RNTI of a respective group member UE, where the cell RNTI of the group leader UE indicates to the network entity that the respective group member UE is in a group with the group leader UE.

In some examples, to support transmitting the message, the message transmission component 1135 may be configured as or otherwise support a means for transmitting the message to the group leader UE for forwarding to the at least one group member UE including an indication of a destination identifier of the at least one group member UE based on the cell RNTI of the group leader UE and the at least one group member UE.

In some examples, the quasi-collocation relationship component 1130 may be configured as or otherwise support a means for updating the level of quasi-collocation relationship between the group leader UE and the at least one group member UE based on a measurement procedure.

In some examples, the level of quasi-collocation relationship includes a first level, and the beam indication component 1150 may be configured as or otherwise support a means for receiving a beam indication from the group leader UE for communications with the group leader UE and the at least one group member UE.

In some examples, the level of quasi-collocation relationship includes a second level, and the time advance component 1155 may be configured as or otherwise support a means for transmitting a same time advance command to the at least one group member UE and each remaining group member UE.

In some examples, the level of quasi-collocation relationship includes a third level, and the pathloss component 1160 may be configured as or otherwise support a means for receiving a pathloss measurement from the group leader UE for communications with the at least one group member UE.

In some examples, the pathloss component 1160 may be configured as or otherwise support a means for receiving, from the group leader UE, an updated pathloss measurement for each of the one or more group member UEs.

In some examples, the level of quasi-collocation relationship includes a fourth level, and the RSRP component 1165 may be configured as or otherwise support a means for receiving a reference signal received power of the group leader UE, of the at least one group member UE, and a second at least one group member UE, where the reference signal received power of the group leader UE, of the at least one group member UE, and a second at least one member UE each satisfy one or more criteria. In some examples, the level of quasi-collocation relationship includes a fourth level, and the handover component 1170 may be configured as or otherwise support a means for transmitting a group handover command to the group leader UE, the at least one group member UE, and the second at least one group member UE.

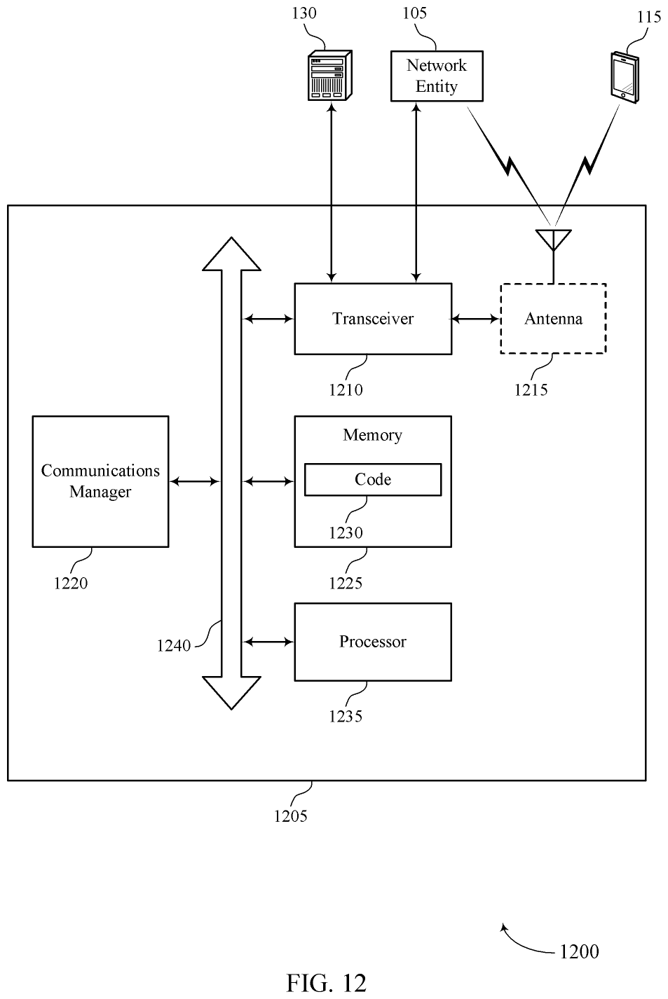

FIG. 12 shows a diagram of a system 1200 including a device 1205 that supports UE group and quasi-collocation configuration management in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting UE group and quasi-collocation configuration management). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for transmitting, to a UE, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi-collocation threshold of the group leader UE. The communications manager 1220 may be configured as or otherwise support a means for receiving signaling indicating a level of quasi-collocation relationship between the group leader UE and each of the one or more group member UEs. The communications manager 1220 may be configured as or otherwise support a means for transmitting a message for at least one group member UE of the one or more group member UEs based on the level of quasi-collocation relationship between the group leader UE and each of the one or more group member UEs.

By including or configuring the communications manager 1220 in accordance with examples as described herein, the device 1205 may support techniques for improved communication reliability, more efficient utilization of communication resources, improved coordination between devices, and improved utilization of processing capability, among other examples.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of UE group and quasi-collocation configuration management as described herein, or the processor 1235 and the memory 1225 may be otherwise configured to perform or support such operations.

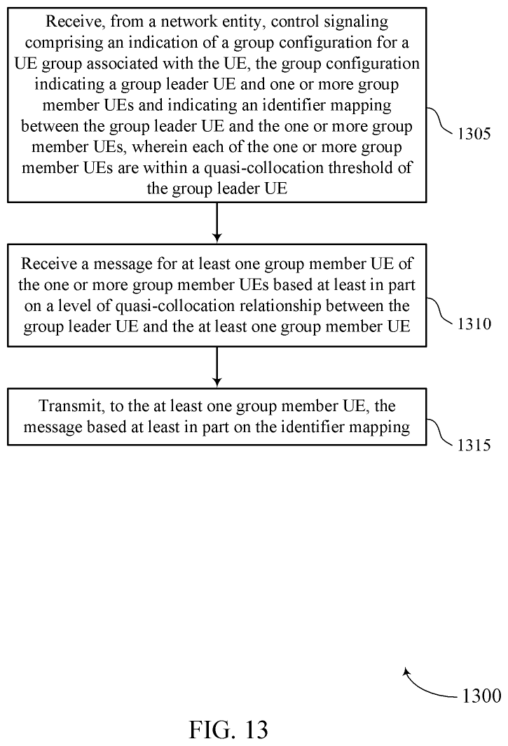

FIG. 13 shows a flowchart illustrating a method 1300 that supports UE group and quasi-collocation configuration management in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi-collocation threshold of the group leader UE. The operations of 1305 may be performed in accordance with examples as disclosed herein. In some examples, aspects of the operations of 1305 may be performed by a group configuration component 725 as described with reference to FIG. 7.

At 1310, the method may include receiving a message for at least one group member UE of the one or more group member UEs based on a level of quasi-collocation relationship between the group leader UE and the at least one group member UE. The operations of 1310 may be performed in accordance with examples as disclosed herein. In some examples, aspects of the operations of 1310 may be performed by a quasi-collocation relationship component 730 as described with reference to FIG. 7.

At 1315, the method may include transmitting, to the at least one group member UE, the message based on the identifier mapping. The operations of 1315 may be performed in accordance with examples as disclosed herein. In some examples, aspects of the operations of 1315 may be performed by a message transmission component 735 as described with reference to FIG. 7.

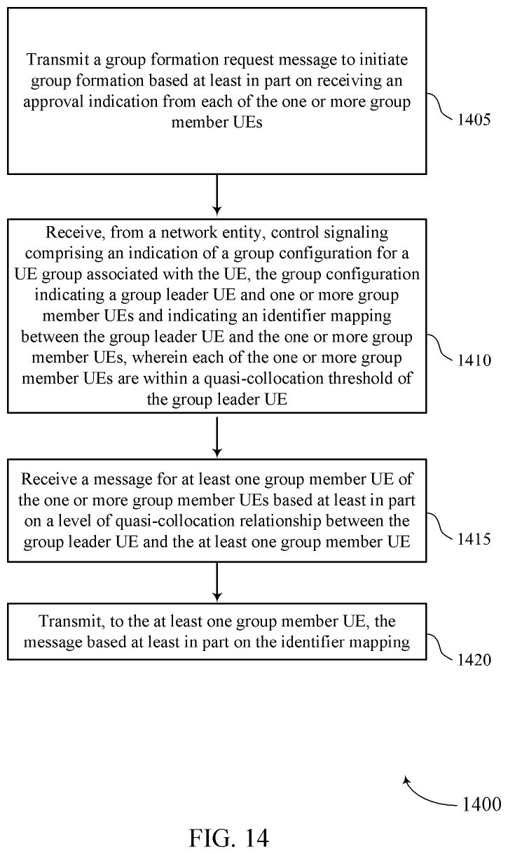

FIG. 14 shows a flowchart illustrating a method 1400 that supports UE group and quasi-collocation configuration management in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting a group formation request message to initiate group formation based on receiving an approval indication from each of the one or more group member UEs. The operations of 1405 may be performed in accordance with examples as disclosed herein. In some examples, aspects of the operations of 1405 may be performed by a group formation request component 740 as described with reference to FIG. 7.

At 1410, the method may include receiving, from a network entity, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi-collocation threshold of the group leader UE. The operations of 1410 may be performed in accordance with examples as disclosed herein. In some examples, aspects of the operations of 1410 may be performed by a group configuration component 725 as described with reference to FIG. 7.

At 1415, the method may include receiving a message for at least one group member UE of the one or more group member UEs based on a level of quasi-collocation relationship between the group leader UE and the at least one group member UE. The operations of 1415 may be performed in accordance with examples as disclosed herein. In some examples, aspects of the operations of 1415 may be performed by a quasi-collocation relationship component 730 as described with reference to FIG. 7.

At 1420, the method may include transmitting, to the at least one group member UE, the message based on the identifier mapping. The operations of 1420 may be performed in accordance with examples as disclosed herein. In some examples, aspects of the operations of 1420 may be performed by a message transmission component 735 as described with reference to FIG. 7.

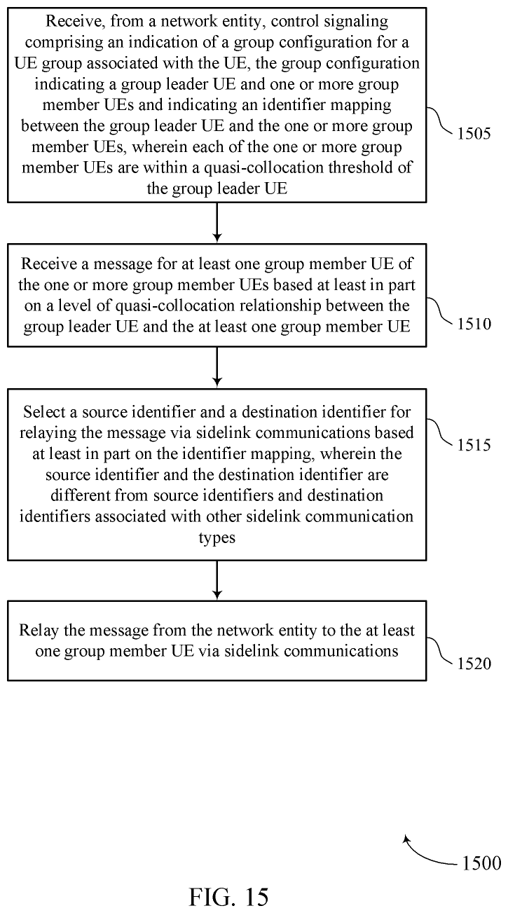

FIG. 15 shows a flowchart illustrating a method 1500 that supports UE group and quasi-collocation configuration management in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi-collocation threshold of the group leader UE. The operations of 1505 may be performed in accordance with examples as disclosed herein. In some examples, aspects of the operations of 1505 may be performed by a group configuration component 725 as described with reference to FIG. 7.

At 1510, the method may include receiving a message for at least one group member UE of the one or more group member UEs based on a level of quasi-collocation relationship between the group leader UE and the at least one group member UE. The operations of 1510 may be performed in accordance with examples as disclosed herein. In some examples, aspects of the operations of 1510 may be performed by a quasi-collocation relationship component 730 as described with reference to FIG. 7.

At 1515, the method may include selecting a source identifier and a destination identifier for relaying the message via sidelink communications based on the identifier mapping, where the source identifier and the destination identifier are different from source identifiers and destination identifiers associated with other sidelink communication types. The operations of 1515 may be performed in accordance with examples as disclosed herein. In some examples, aspects of the operations of 1515 may be performed by an identifier component 745 as described with reference to FIG. 7.

At 1520, the method may include relaying the message from the network entity to the at least one group member UE via sidelink communications. The operations of 1520 may be performed in accordance with examples as disclosed herein. In some examples, aspects of the operations of 1520 may be performed by a message transmission component 735 as described with reference to FIG. 7.

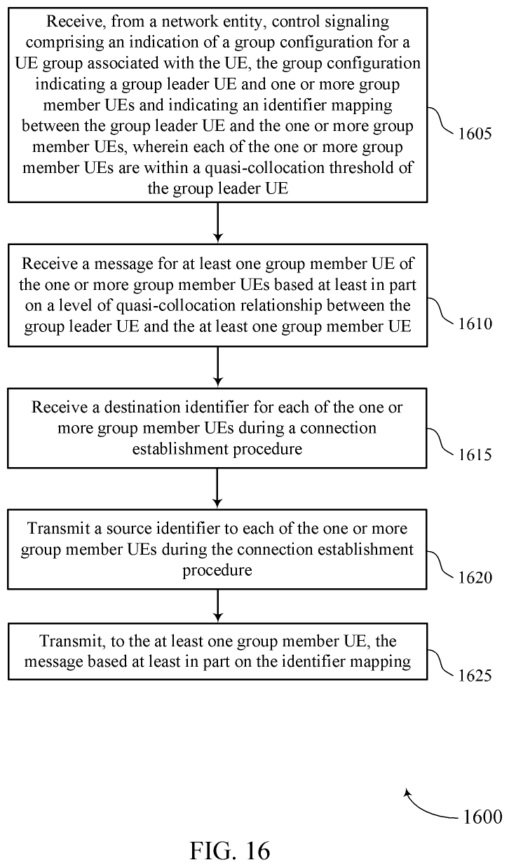

FIG. 16 shows a flowchart illustrating a method 1600 that supports UE group and quasi-collocation configuration management in accordance with one or more aspects of the present disclosure. The operations of the method 1600 may be implemented by a UE or its components as described herein. For example, the operations of the method 1600 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi-collocation threshold of the group leader UE. The operations of 1605 may be performed in accordance with examples as disclosed herein. In some examples, aspects of the operations of 1605 may be performed by a group configuration component 725 as described with reference to FIG. 7.

At 1610, the method may include receiving a message for at least one group member UE of the one or more group member UEs based on a level of quasi-collocation relationship between the group leader UE and the at least one group member UE. The operations of 1610 may be performed in accordance with examples as disclosed herein. In some examples, aspects of the operations of 1610 may be performed by a quasi-collocation relationship component 730 as described with reference to FIG. 7.

At 1615, the method may include receiving a destination identifier for each of the one or more group member UEs during a connection establishment procedure. The operations of 1615 may be performed in accordance with examples as disclosed herein. In some examples, aspects of the operations of 1615 may be performed by an identifier component 745 as described with reference to FIG. 7.

At 1620, the method may include transmitting a source identifier to each of the one or more group member UEs during the connection establishment procedure. The operations of 1620 may be performed in accordance with examples as disclosed herein. In some examples, aspects of the operations of 1620 may be performed by an identifier component 745 as described with reference to FIG. 7.

At 1625, the method may include transmitting, to the at least one group member UE, the message based on the identifier mapping. The operations of 1625 may be performed in accordance with examples as disclosed herein. In some examples, aspects of the operations of 1625 may be performed by a message transmission component 735 as described with reference to FIG. 7.

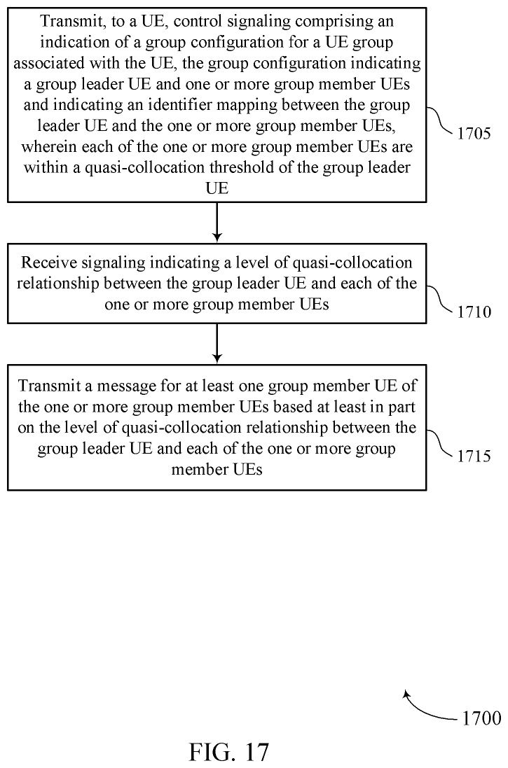

FIG. 17 shows a flowchart illustrating a method 1700 that supports UE group and quasi-collocation configuration management in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi-collocation threshold of the group leader UE. The operations of 1705 may be performed in accordance with examples as disclosed herein. In some examples, aspects of the operations of 1705 may be performed by a group configuration transmission component 1125 as described with reference to FIG. 11.

At 1710, the method may include receiving signaling indicating a level of quasi-collocation relationship between the group leader UE and each of the one or more group member UEs. The operations of 1710 may be performed in accordance with examples as disclosed herein. In some examples, aspects of the operations of 1710 may be performed by a quasi-collocation relationship component 1130 as described with reference to FIG. 11.

At 1715, the method may include transmitting a message for at least one group member UE of the one or more group member UEs based on the level of quasi-collocation relationship between the group leader UE and each of the one or more group member UEs. The operations of 1715 may be performed in accordance with examples as disclosed herein. In some examples, aspects of the operations of 1715 may be performed by a message transmission component 1135 as described with reference to FIG. 11.

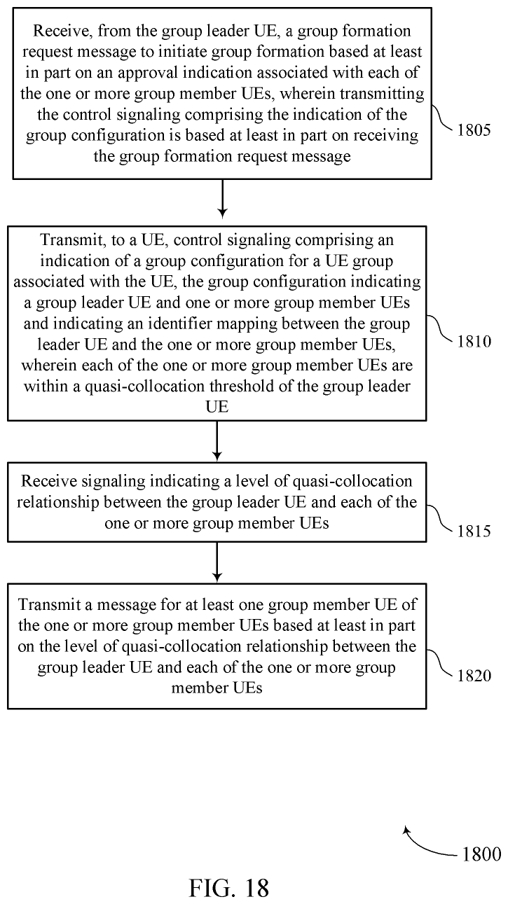

FIG. 18 shows a flowchart illustrating a method 1800 that supports UE group and quasi-collocation configuration management in accordance with one or more aspects of the present disclosure. The operations of the method 1800 may be implemented by a network entity or its components as described herein. For example, the operations of the method 1800 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1805, the method may include receiving, from the group leader UE, a group formation request message to initiate group formation based on an approval indication associated with each of the one or more group member UEs, where transmitting the control signaling including the indication of the group configuration is based on receiving the group formation request message. The operations of 1805 may be performed in accordance with examples as disclosed herein. In some examples, aspects of the operations of 1805 may be performed by a group formation component 1140 as described with reference to FIG. 11.

At 1810, the method may include transmitting, to a UE, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi-collocation threshold of the group leader UE. The operations of 1810 may be performed in accordance with examples as disclosed herein. In some examples, aspects of the operations of 1810 may be performed by a group configuration transmission component 1125 as described with reference to FIG. 11.

At 1815, the method may include receiving signaling indicating a level of quasi-collocation relationship between the group leader UE and each of the one or more group member UEs. The operations of 1815 may be performed in accordance with examples as disclosed herein. In some examples, aspects of the operations of 1815 may be performed by a quasi-collocation relationship component 1130 as described with reference to FIG. 11.

At 1820, the method may include transmitting a message for at least one group member UE of the one or more group member UEs based on the level of quasi-collocation relationship between the group leader UE and each of the one or more group member UEs. The operations of 1820 may be performed in accordance with examples as disclosed herein. In some examples, aspects of the operations of 1820 may be performed by a message transmission component 1135 as described with reference to FIG. 11.

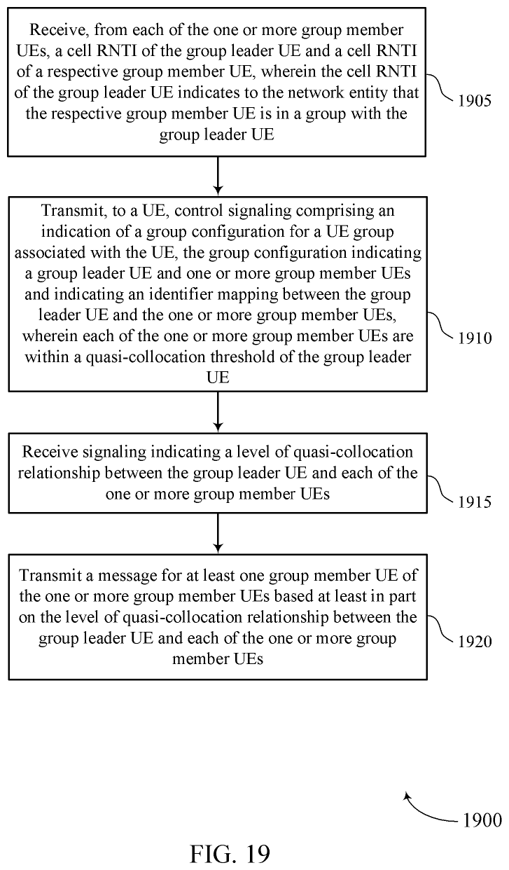

FIG. 19 shows a flowchart illustrating a method 1900 that supports UE group and quasi-collocation configuration management in accordance with one or more aspects of the present disclosure. The operations of the method 1900 may be implemented by a network entity or its components as described herein. For example, the operations of the method 1900 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1905, the method may include receiving, from each of the one or more group member UEs, a cell RNTI of the group leader UE and a cell RNTI of a respective group member UE, where the cell RNTI of the group leader UE indicates to the network entity that the respective group member UE is in a group with the group leader UE. The operations of 1905 may be performed in accordance with examples as disclosed herein. In some examples, aspects of the operations of 1905 may be performed by an RNTI component 1145 as described with reference to FIG. 11.

At 1910, the method may include transmitting, to a UE, control signaling including an indication of a group configuration for a UE group associated with the UE, the group configuration indicating a group leader UE and one or more group member UEs and indicating an identifier mapping between the group leader UE and the one or more group member UEs, where each of the one or more group member UEs are within a quasi-collocation threshold of the group leader UE. The operations of 1910 may be performed in accordance with examples as disclosed herein. In some examples, aspects of the operations of 1910 may be performed by a group configuration transmission component 1125 as described with reference to FIG. 11.

At 1915, the method may include receiving signaling indicating a level of quasi-collocation relationship between the group leader UE and each of the one or more group member UEs. The operations of 1915 may be performed in accordance with examples as disclosed herein. In some examples, aspects of the operations of 1915 may be performed by a quasi-collocation relationship component 1130 as described with reference to FIG. 11.

At 1920, the method may include transmitting a message for at least one group member UE of the one or more group member UEs based on the level of quasi-collocation relationship between the group leader UE and each of the one or more group member UEs. The operations of 1920 may be performed in accordance with examples as disclosed herein. In some examples, aspects of the operations of 1920 may be performed by a message transmission component 1135 as described with reference to FIG. 11.

The following provides an overview of aspects of the present disclosure:

Aspect 1: A method for wireless communication at a UE, comprising: receiving, from a network entity, control signaling comprising an indication of a group configuration for a UE group associated with the UE, the group configuration indicating a group leader UE and one or more group member UEs and indicating an identifier mapping between the group leader UE and the one or more group member UEs, wherein each of the one or more group member UEs are within a quasi co-location threshold of the group leader UE; receiving a message for at least one group member UE of the one or more group member UEs based at least in part on a level of quasi co-location relationship between the group leader UE and the at least one group member UE; and transmitting, to the at least one group member UE, the message based at least in part on the identifier mapping.

Aspect 2: The method of aspect 1, further comprising: transmitting a group formation request message to initiate group formation based at least in part on receiving an approval indication from each of the one or more group member UEs, wherein receiving the control signaling comprising the indication of the group configuration is based at least in part on transmitting the group formation request message.

Aspect 3: The method of aspect 2, wherein the group formation request message comprises a cell radio network temporary identifier (RNTI) for each of the one or more group member UEs and the group leader UE.

Aspect 4: The method of any of aspects 2 through 3, wherein the group configuration further indicates a group radio network temporary identifier (RNTI) based at least in part on the group formation request message.

Aspect 5: The method of aspect 4, further comprising: transmitting, via sidelink communications, an indication of the group RNTI to each of the one or more group member UEs.

Aspect 6: The method of aspect 5, wherein the indication of the group RNTI is transmitted via sidelink control information.

Aspect 7: The method of any of aspects 4 through 6, wherein the group RNTI is randomly generated.

Aspect 8: The method of any of aspects 4 through 7, further comprising: updating the group RNTI based at least in part on a periodic refresh window.

Aspect 9: The method of aspect 8, wherein the periodic refresh window is determined by the network entity or the group leader UE.

Aspect 10: The method of any of aspects 4 through 9, further comprising: updating the group RNTI based at least in part on adding randomly-generated group RNTI offset to the group RNTI.

Aspect 11: The method of any of aspects 4 through 10, further comprising: receiving a second group RNTI based at least in part on a member UE joining or leaving the group configuration.

Aspect 12: The method of any of aspects 2 through 11, wherein the group configuration further indicates a set of cell radio network temporary identifiers (RNTIs) for each of the one or more group member UEs based at least in part on the group formation request message.

Aspect 13: The method of aspect 12, where a first cell RNTI of the set of cell RNTIs identifies group member UE-specific communications with the network entity and a second cell RNTI of the set of cell RNTIs identifies group leader UE communications and group member UE communications with the network entity.

Aspect 14: The method of aspect 13, further comprising: receiving a message having the second cell RNTI: determining that decoding of the message at a group member UE is unsuccessful; and relaying the message to the group member UE.

Aspect 15: The method of any of aspects 2 through 14, further comprising: transmitting a cell radio network temporary identifier (RNTI) of the group leader UE to each of the one or more group member UEs from which an approval indication has been received.

Aspect 16: The method of any of aspects 1 through 15, wherein the message includes a destination identifier for the at least one group member UE, and wherein transmitting the message to the at least one group member UE comprises: relaying the message from the network entity to the at least one group member UE based at least in part on the destination identifier.

Aspect 17: The method of any of aspects 1 through 16, wherein transmitting the message to the at least one group member UE comprises: relaying the message from the network entity to the at least one group member UE via sidelink communications, the method further comprising: selecting a source identifier and a destination identifier for relaying the message via sidelink communications based at least in part on the identifier mapping, wherein the source identifier and the destination identifier are different from source identifiers and destination identifiers associated with other sidelink communication types.

Aspect 18: The method of aspect 17, further comprising: maintaining the identifier mapping for future communications with the one or more group member UEs.

Aspect 19: The method of any of aspects 17 through 18, wherein the other sidelink communication types comprise groupcast communication, or unicast communication, or both.

Aspect 20: The method of any of aspects 1 through 19, further comprising: receiving a destination identifier for each of the one or more group member UEs during a connection establishment procedure; and transmitting a source identifier to each of the one or more group member UEs during the connection establishment procedure.

Aspect 21: The method of aspect 20, wherein the connection establishment procedure is a PC5 unicast link establishment procedure.

Aspect 22: The method of any of aspects 1 through 21, further comprising: transmitting signaling indicating the level of quasi co-location relationship between the group leader UE and each of the one or more group member UEs.

Aspect 23: The method of aspect 22, wherein a first level of quasi co-location relationship between a first group member UE and the group leader UE is different than a second level of quasi co-location relationship between a second group member UE and the group leader UE.

Aspect 24: The method of any of aspects 22 through 23, wherein a first level of quasi co-location relationship between a first group member UE and the group leader UE is the same as a second level of quasi co-location relationship between a second group member UE and the group leader UE.

Aspect 25: The method of any of aspects 1 through 24, wherein the level of quasi co-location relationship between the group leader UE and the at least one group member UE is based on a location of the at least one group member UE within the group leader UE.

Aspect 26: The method of any of aspects 1 through 25, wherein the level of quasi co-location relationship between the group leader UE and the at least one group member UE comprises at least one level of a plurality of levels of quasi co-location relationships.

Aspect 27: The method of aspect 26, wherein a first level is based at least in part on a common direction of travel between the group leader UE and the at least one group member UE.

Aspect 28: The method of any of aspects 26 through 27, wherein a second level is based at least in part on a common timing offset between the group leader UE and the at least one group member UE.

Aspect 29: The method of any of aspects 26 through 28, wherein a third level is based at least in part on a pathloss measurement of the group leader UE and a pathloss measurement of the at least one group member UE satisfying a criterion.

Aspect 30: The method of any of aspects 26 through 29, wherein a fourth level is based at least in part on a reference signal received power of the group leader UE and a reference signal received power of the at least one group member UE satisfying a criterion.

Aspect 31: The method of any of aspects 1 through 30, wherein the level of quasi co-location relationship between the group leader UE and the at least one group member UE is determined by the network entity, the group leader UE, or the at least one group member UE based at least in part on a measurement procedure.

Aspect 32: The method of any of aspects 1 through 31, wherein each group member UE is associated with a default level of quasi co-location relationship with the group leader UE during group initiation.

Aspect 33: The method of any of aspects 1 through 32, wherein each group member UE is associated with at least one common level of quasi co-location relationship with the group leader UE.

Aspect 34: The method of any of aspects 1 through 33, further comprising: updating the level of quasi co-location relationship between the group leader UE and the at least one group member UE based at least in part on a measurement procedure.

Aspect 35: The method of any of aspects 1 through 34, further comprising: receiving, from the at least one group member UE, an indication of an updated level of quasi co-location relationship between the group leader UE and the at least one group member UE.

Aspect 36: The method of any of aspects 1 through 35, wherein receiving the control signaling comprises: receiving radio resource control signaling.

Aspect 37: A method for wireless communication at a network entity, comprising: transmitting, to a UE, control signaling comprising an indication of a group configuration for a UE group associated with the UE, the group configuration indicating a group leader UE and one or more group member UEs and indicating an identifier mapping between the group leader UE and the one or more group member UEs, wherein each of the one or more group member UEs are within a quasi co-location threshold of the group leader UE; receiving signaling indicating a level of quasi co-location relationship between the group leader UE and each of the one or more group member UEs; and transmitting a message for at least one group member UE of the one or more group member UEs based at least in part on the level of quasi co-location relationship between the group leader UE and each of the one or more group member UEs.

Aspect 38: The method of aspect 37, further comprising: receiving, from the group leader UE, a group formation request message to initiate group formation based at least in part on an approval indication associated with each of the one or more group member UEs, wherein transmitting the control signaling comprising the indication of the group configuration is based at least in part on receiving the group formation request message.

Aspect 39: The method of aspect 38, wherein the group configuration further indicates a group radio network temporary identifier (RNTI) based at least in part on the group formation request message.

Aspect 40: The method of aspect 39, further comprising: transmitting a common message for each of the one or more group member UEs comprising a scrambled group RNTI.

Aspect 41: The method of aspect 40, wherein the group RNTI is scrambled via downlink control information.

Aspect 42: The method of any of aspects 39 through 41, further comprising: updating the group RNTI based at least in part on a periodic refresh window.

Aspect 43: The method of aspect 42, further comprising: determining the periodic refresh window; and transmitting an indication of the periodic refresh window to the group leader UE.

Aspect 44: The method of any of aspects 37 through 43, further comprising: receiving, from each of the one or more group member UEs, a cell RNTI of the group leader UE and a cell RNTI of a respective group member UE, wherein the cell RNTI of the group leader UE indicates to the network entity that the respective group member UE is in a group with the group leader UE.

Aspect 45: The method of aspect 44, wherein transmitting the message comprises: transmitting the message to the group leader UE for forwarding to the at least one group member UE including an indication of a destination identifier of the at least one group member UE based at least in part on the cell RNTI of the group leader UE and the at least one group member UE.

Aspect 46: The method of any of aspects 37 through 45, further comprising: updating the level of quasi co-location relationship between the group leader UE and the at least one group member UE based at least in part on a measurement procedure.

Aspect 47: The method of any of aspects 37 through 46, wherein the level of quasi co-location relationship comprises a first level, the method further comprising: receiving a beam indication from the group leader UE for communications with the group leader UE and the at least one group member UE.

Aspect 48: The method of any of aspects 37 through 47, wherein the level of quasi co-location relationship comprises a second level, the method further comprising: transmitting a same time advance command to the at least one group member UE and each remaining group member UE.

Aspect 49: The method of any of aspects 37 through 48, wherein the level of quasi co-location relationship comprises a third level, the method further comprising: receiving a pathloss measurement from the group leader UE for communications with the at least one group member UE.

Aspect 50: The method of aspect 49, further comprising: receiving, from the group leader UE, an updated pathloss measurement for each of the one or more group member UEs.

Aspect 51: The method of any of aspects 37 through 50, wherein the level of quasi co-location relationship comprises a fourth level, the method further comprising: receiving a reference signal received power of the group leader UE, of the at least one group member UE, and a second at least one group member UE, wherein the reference signal received power of the group leader UE, of the at least one group member UE, and a second at least one member UE each satisfy one or more criteria; and transmitting a group handover command to the group leader UE, the at least one group member UE, and the second at least one group member UE.

Aspect 52: An apparatus for wireless communication at a UE, comprising a processor: memory coupled with the processor; and instructions stored in the memory and executable by the processor to cause the apparatus to perform a method of any of aspects 1 through 36.

Aspect 53: An apparatus for wireless communication at a UE, comprising at least one means for performing a method of any of aspects 1 through 36.

Aspect 54: A non-transitory computer-readable medium storing code for wireless communication at a UE, the code comprising instructions executable by a processor to perform a method of any of aspects 1 through 36.

Aspect 55: An apparatus for wireless communication at a network entity, comprising a processor: memory coupled with the processor; and instructions stored in the memory and executable by the processor to cause the apparatus to perform a method of any of aspects 37 through 51.

Aspect 56: An apparatus for wireless communication at a network entity, comprising at least one means for performing a method of any of aspects 37 through 51.

Aspect 57: A non-transitory computer-readable medium storing code for wireless communication at a network entity, the code comprising instructions executable by a processor to perform a method of any of aspects 37 through 51.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of′ or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a network entity, control signaling comprising an indication of a group configuration for a UE group associated with the UE, the group configuration indicating a group leader UE and one or more group member UEs and indicating an identifier mapping between the group leader UE and the one or more group member UEs, wherein each of the one or more group member UEs are within a quasi-collocation threshold of the group leader UE:
receiving a message for at least one group member UE of the one or more group member UEs based at least in part on a level of quasi-collocation relationship between the group leader UE and the at least one group member UE; and
transmitting, to the at least one group member UE, the message based at least in part on the identifier mapping.

2. The method of claim 1, further comprising:
transmitting a group formation request message to initiate group formation based at least in part on receiving an approval indication from each of the one or more group member UEs, wherein receiving the control signaling comprising the indication of the group configuration is based at least in part on transmitting the group formation request message.

3. The method of claim 2, wherein the group formation request message comprises a cell radio network temporary identifier (RNTI) for each of the one or more group member UEs and the group leader UE.

4. The method of claim 2, wherein the group configuration further indicates a group radio network temporary identifier (RNTI) based at least in part on the group formation request message.

5. The method of claim 4, further comprising:
transmitting, via sidelink communications, an indication of the group RNTI to each of the one or more group member UEs.

6. The method of claim 4, further comprising:
updating the group RNTI based at least in part on adding a randomly-generated group RNTI offset to the group RNTI.

7. The method of claim 4, further comprising:
receiving a second group RNTI based at least in part on a member UE joining or leaving the group configuration.

8. The method of claim 2, wherein:
the group configuration further indicates a set of cell radio network temporary identifiers (RNTIs) for each of the one or more group member UEs based at least in part on the group formation request message; and
a first cell RNTI of the set of cell RNTIs identifies group member UE-specific communications with the network entity and a second cell RNTI of the set of cell RNTIs identifies group leader UE communications and group member UE communications with the network entity.

9. The method of claim 2, further comprising:
transmitting a cell radio network temporary identifier (RNTI) of the group leader UE to each of the one or more group member UEs from which an approval indication has been received.

10. The method of claim 1, further comprising:
transmitting signaling indicating the level of quasi-collocation relationship between the group leader UE and each of the one or more group member UEs.

11. The method of claim 1, wherein the level of quasi-collocation relationship between the group leader UE and the at least one group member UE comprises at least one level of a plurality of levels of quasi-collocation relationships.

12. The method of claim 11, wherein a first level is based at least in part on a common direction of travel between the group leader UE and the at least one group member UE.

13. The method of claim 11, wherein a second level is based at least in part on a common timing offset between the group leader UE and the at least one group member UE.

14. The method of claim 11, wherein a third level is based at least in part on a pathloss measurement of the group leader UE and a pathloss measurement of the at least one group member UE satisfying a criterion.

15. The method of claim 11, wherein a fourth level is based at least in part on a reference signal received power of the group leader UE and a reference signal received power of the at least one group member UE satisfying a criterion.

16. The method of claim 1, wherein the message includes a destination identifier for the at least one group member UE, and wherein transmitting the message to the at least one group member UE comprises:
relaying the message from the network entity to the at least one group member UE based at least in part on the destination identifier.

17. The method of claim 1, wherein transmitting the message to the at least one group member UE comprises:
relaying the message from the network entity to the at least one group member UE via sidelink communications, the method further comprising:
selecting a source identifier and a destination identifier for relaying the message via sidelink communications based at least in part on the identifier mapping, wherein the source identifier and the destination identifier are different from source identifiers and destination identifiers associated with other sidelink communication types.

18. The method of claim 1, further comprising:
receiving a destination identifier for each of the one or more group member UEs during a connection establishment procedure; and
transmitting a source identifier to each of the one or more group member UEs during the connection establishment procedure.

19. A method for wireless communication at a network entity, comprising:
transmitting, to a user equipment (UE), control signaling comprising an indication of a group configuration for a UE group associated with the UE, the group configuration indicating a group leader UE and one or more group member UEs and indicating an identifier mapping between the group leader UE and the one or more group member UEs, wherein each of the one or more group member UEs are within a quasi-collocation threshold of the group leader UE:
receiving signaling indicating a level of quasi-collocation relationship between the group leader UE and each of the one or more group member UEs; and
transmitting a message for at least one group member UE of the one or more group member UEs based at least in part on the level of quasi-collocation relationship between the group leader UE and each of the one or more group member UEs.

20. The method of claim 19, further comprising:
receiving, from the group leader UE, a group formation request message to initiate group formation based at least in part on an approval indication associated with each of the one or more group member UEs, wherein transmitting the control signaling comprising the indication of the group configuration is based at least in part on receiving the group formation request message.

21. The method of claim 19, further comprising:
receiving, from each of the one or more group member UEs, a cell radio network temporary identifiers (RNTIs) of the group leader UE and a cell RNTI of a respective group member UE, wherein the cell RNTI of the group leader UE indicates to the network entity that the respective group member UE is in a group with the group leader UE.

22. The method of claim 21, wherein transmitting the message comprises:
transmitting the message to the group leader UE for forwarding to the at least one group member UE including an indication of a destination identifier of the at least one group member UE based at least in part on the cell RNTI of the group leader UE and the at least one group member UE.

23. The method of claim 19, wherein the level of quasi-collocation relationship comprises a first level, the method further comprising:
receiving a beam indication from the group leader UE for communications with the group leader UE and the at least one group member UE.

24. The method of claim 19, wherein the level of quasi-collocation relationship comprises a second level, the method further comprising:
transmitting a same time advance command to the at least one group member UE and each remaining group member UE.

25. The method of claim 19, wherein the level of quasi-collocation relationship comprises a third level, the method further comprising:
receiving a pathloss measurement from the group leader UE for communications with the at least one group member UE.

26. The method of claim 19, wherein the level of quasi-collocation relationship comprises a fourth level, the method further comprising:
receiving a reference signal received power of the group leader UE, of the at least one group member UE, and a second at least one group member UE, wherein the reference signal received power of the group leader UE, of the at least one group member UE, and a second at least one member UE each satisfy one or more criteria; and
transmitting a group handover command to the group leader UE, the at least one group member UE, and the second at least one group member UE.

27. A method for wireless communication at a network entity, comprising:
transmitting, to a user equipment (UE), control signaling comprising an indication of a group configuration for a UE group associated with the UE, the group configuration indicating a group leader UE and one or more group member UEs and indicating an identifier mapping between the group leader UE and the one or more group member UEs, wherein each of the one or more group member UEs are within a quasi-collocation threshold of the group leader UE:
receiving signaling indicating a level of quasi-collocation relationship between the group leader UE and each of the one or more group member UEs; and
transmitting a message for at least one group member UE of the one or more group member UEs based at least in part on the level of quasi-collocation relationship between the group leader UE and each of the one or more group member UEs.

28. The method of claim 27, further comprising:
receiving, from the group leader UE, a group formation request message to initiate group formation based at least in part on an approval indication associated with each of the one or more group member UEs, wherein transmitting the control signaling comprising the indication of the group configuration is based at least in part on receiving the group formation request message.

29. The method of claim 28, wherein the group configuration further indicates a group radio network temporary identifier (RNTI) based at least in part on the group formation request message.

30. An apparatus for wireless communication at a user equipment (UE), comprising:
a processor:
memory coupled with the processor; and
instructions stored in the memory and executable by the processor to cause the apparatus to:
receive, from a network entity, control signaling comprising an indication of a group configuration for a UE group associated with the UE, the group configuration indicating a group leader UE and one or more group member UEs and indicating an identifier mapping between the group leader UE and the one or more group member UEs, wherein each of the one or more group member UEs are within a quasi-collocation threshold of the group leader UE:
receive a message for at least one group member UE of the one or more group member UEs based at least in part on a level of quasi-collocation relationship between the group leader UE and the at least one group member UE; and
transmit, to the at least one group member UE, the message based at least in part on the identifier mapping.
